(19) United States
(12) Patent Application Publication
(10) Pub. No.: US 2005/0138326 A1
(43) Pub. Date: Jun. 23, 2005

(54) SIMD type parallel operation apparatus used for parallel operation of image signal or the like

(75) Inventors: Kengo Terada, Osaka (JP); Takeshi Tanaka, Osaka (JP); Hideshi Nishida, Hyogo (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/009,056

(22) Filed: Dec. 13, 2004

(30) Foreign Application Priority Data
Dec. 19, 2003 (JP) P2003-423077

(51) Int. Cl. G06F 15/00

(52) U.S. Cl. 712/22

(57) ABSTRACT

A parallel operation apparatus of a SIMD type comprises a processor element group of the SIMD type including a plurality of processor elements, wherein the respective processor elements simultaneously execute an identical operation, a data memory accessible from the respective processor elements in the processor element group, and an address conversion unit for converting an address with respect to the data memory accessed by the processor elements in accordance with a control signal by changing bit positions of the address. The address conversion unit preferably rearranges a first bit, a second bit, and a third bit from a lower order of address data into the second bit, the third bit, and the first bit from the lower order in the change of the bit positions.

### BACKGROUND OF THE INVENTION

1. Field of the Invention

The present invention relates to a parallel operation apparatus of a SIMD type for executing a parallel operation to an image signal such as an image CODEC (Coder Decoder) or the like.

2. Description of the Related Art

In a significant advancement of technology in the field of a digital image apparatus in recent years, an image processing, such as compression/extension and filtering with respect to the image, has been highly complicated. In the image processing, the processing is executed in a frame format or a field format with respect to the images stored in a memory respectively in the frame format or the field format. The frame format refers to a format wherein a top field and a bottom field alternately constitute the image. The field format refers to a format wherein the top field and the bottom field are respectively disposed at different positions, each as a lump.

FIG. 33A shows a frame format comprised of horizontal eight pixels×vertical eight pixels. FIG. 33B shows a field format comprised of horizontal eight pixels×vertical eight pixels. Ti (i=00-31) denotes a pixel unit of the top field. Bi (i=00-31) denotes a pixel unit of the bottom field. Numerals 000-111 denote binary addresses. As an example of the image processing in the frame format or the field format can be mentioned, for example, MC processing (Motion Compensation processing) of MPEG (Moving Picture Experts Group). Though the details are omitted here, the MC processing includes a frame prediction for predicting the movement of the image from the frame-format image and a field prediction for predicting the movement of the image from the field-format image. In that case, a read processing with respect to the image data stored in the frame format or the field format is further executed respectively in the frame format and the field format. As a processing of the same type, DCT (Discrete Cosine Transform) processing of MPEG can be mentioned. Though the details are omitted again, the DCT processing, which is a type of Fourier conversion, is a conversion of a two-dimensional image into a two-dimensional frequency. The DCT processing includes two types of processings, one of which is frame DCT for processing the frame-format image and field DCT for processing the field-format image. The read of the image data was mentioned earlier, however the image data is written in the same manner.

In reading image data corresponding to an address, some data need not be read, as an example of which, encoding data for MPEG decoding can be mentioned. Data called CBP (Coded Block Pattern) is used therein. Though the details are omitted here, the CBP is used to judge whether or not blocks in a macro block are respectively encoded. When a CBP value with respect to a block is “0”, the block is not encoded and all of the encoding data is “0”, which makes it unnecessary to read the data.

An issue to be dealt with here is that, when image data in a data memory is not stored in a desired format, itis necessary to rearrange the order of reading the data. For example, when the image is arranged as in FIG. 33A, the data can be read in accordance with the serial addresses of 000, 001, 010, . . . , 111 in the case of reading the data in the frame format, the data has to be read in the order of the addresses 000, 010, 100, 110, 001, 011, 101, and 111 when the data is read in the field format.

No. 07-121687 of the Publication of the Unexamined Patent Applications disclosed a technology successfully solving the issue by executing one-bit rotation. FIG. 34 shows a configuration of an operation apparatus according to the technology. The operation apparatus is a parallel operation apparatus of the SIMD type and comprises eight processor elements 16. FIG. 35 shows a configuration of the processor element 16. The image data is stored in a data memory 18 in such a frame format as shown in FIG. 33A. In a data address storage memory 19, the read order of the image data is indicated by the addresses and thereby memorized.

FIG. 37A shows the data address storage memory 19 for reading the data in the frame format. FIG. 37B shows the data address storage memory 19 for reading the data in the field format. Numerals 000-111 shown in FIGS. 37A and 37B are represented in the binary notation, while numerals 0-7 in blankets are represented in the decimal notation.

FIG. 36 shows a configuration of a data address conversion circuit 20. A conversion device selection signal 24 is changed over depending on if the read order stored in the data address storage memory 19 is for the frame format or the field format. A rotating circuit 28 is set so as to execute the one-bit rotation to left when the frame-format read order is stored, and one-bit rotation to right when the field-format read order is stored. A frame/field selection signal 25 is used to select the read format. An address conversion selector 27 is set so that an post-rotation address 26 is selected when it is desired to read the data in the read order different to the read order stored in the data address storage memory 19, while a pre-conversion address 21 is selected otherwise.

FIGS. 38A and 38B respectively show an operation of the rotating circuit 28. FIG. 38A shows the case of storing the frame-format read order in the data address storage memory 19, while FIG. 38B shows the case of storing the field-format read order in the data address storage memory 19.

Providing a description referring to FIG. 38A, the pre-conversion addresses 21 are sequentially inputted to the data address conversion circuit 20 from the upper side, the four addresses in the first half are converted into the addresses with respect to the top field, while the four address in the latter half are converted into the addresses with respect to the bottom field. According to the foregoing method, the image arranged in the memory in the frame format, as shown in FIG. 33A, can be obtained in the field format.

However, the foregoing method is premised on the data arrangement in the frame format. Therefore, the foregoing method cannot be adopted to the case where the it is desired to obtain the image in the frame format from the image arranged in the field format.

Further, the foregoing method, which is based on the assumption that a line of the relevant image can be disposed in a line of the memory, cannot respond to the case where the line of the relevant image is larger than the line of the memory in size.

In any case where the foregoing method cannot be adopted, such as reading the image stored in the field format in the frame format, it becomes necessary to manipulate the address of the data to be read. It would require a program capable of corresponding to the read formats increasing a program size for the operation apparatus to execute the address manipulation. The data writing faces the same problem.

As a solution, it is an option to rewrite the data into data in a desired format. However, such a solution requiring the repetition of load/store in the operation apparatus would lead to an increased throughput in the operation apparatus. Further, a solution using DMA (Direct Memory Access) includes the problem that a DMA instruction is issued more often. Further, as a different option, an address conversion table can be previously prepared. The foregoing method, however, requires the number of conversion tables corresponding to different types of conversions, resulting in an increased necessary memory size.

Those methods according to the conventional technology do not include a mechanism for controlling the read by means of the address, therefore are incapable of controlling any unnecessary read with respect to the memory. Thus, power consumed for reading the data, which is later proven to be the unnecessary data, results in vain due to the unnecessary access to the memory. It would be convenient to arrange a data-read instruction not to be issued when an access is made to an address where the unnecessary data is stored. However, when such a judgment is made in the operation apparatus, a program installed in the operation apparatus would be complicated.

### SUMMARY OF THE INVENTION

A first parallel operation apparatus of a SIMD type according to the present invention comprises, a processor element group of a SIMD type including a plurality of processor elements, wherein the respective processor elements simultaneously execute an identical operation, a data memory accessible from the respective processor elements, and an address conversion unit for converting an address with respect to the data memory accessed by the processor elements in accordance with a control signal by changing bit positions of the address.

In the first SIMD-type parallel operation apparatus, when it is premised that image data in the data memory is arranged in a frame format, the address conversion unit is controlled in accordance with the setting of the control signal to thereby change over to the state where the access is made in the frame format without changing the address at which the processor elements access the data memory, and to the state where the access is made in a field format by converting the address into a different address. Alternatively, when it is premised that the image data in the data memory is arranged in the field format, the address conversion unit is controlled in accordance with the setting of the control signal to thereby change over to the state where the access is made in the field format without changing the address at which the processor element accesses the data memory, and to the state where the access is made in the frame format by converting the address into a different address. As described, according to the first SIMD-type parallel operation apparatus, the data memory is accessible in either the frame format or the field format.

In the foregoing configuration, the bit positions can be changed in the address conversion unit in the following different manners.

1) The address conversion unit rearranges a first bit, second bid and third bit from a low order of the address data respectively to the second bit, third bit, and first bit from the lower order to thereby change the bit positions.

When eight pixels are a unit for per processing and it is premised that the image data in the data memory is arranged in the frame format, the described address conversion enables the access in the field format.

2) The address conversion unit rearranges the first bit, second bid and third bit from the lower order of the address data respectively to the third bit, first bit, and second bit from the lower order to thereby change the bit positions.

When eight pixels are a unit for per processing and it is premised that the image data in the data memory is arranged in the field format, the described address conversion enables the access in the frame format.

3) The address conversion unit rearranges the first bit, second bid, third bit, fourth bit and fifth bit from the lower order of the address data respectively to the first bit, third bit, fourth bit, fifth bit and second bit from the lower order to thereby change the bit positions.

In the case where 16 pixels are a unit per processing, and a line of the image data cannot be disposed in a line of the memory due to a limited memory width, therefore arranging a surplus part of the line in a subsequent line, and further it is premised that the image data in the data memory is arranged in the frame format, the foregoing address conversion enables the access in the field format. In the foregoing manner, it is unnecessary to provide a program responding to the access formats, thereby reducing a code size. Further, it is unnecessary to rearrange the data, which leads to the reduction of the throughput.

4) The address conversion unit rearranges the first bit, second bid, third bit, fourth bit and fifth bit from the lower order of the address data respectively to the first bit, fifth bit, second bit, third bit and fourth bit from the lower order to thereby change the bit positions.

When 16 pixels are a unit per processing, and a line of the image data cannot be disposed in a line of the memory due to the limited memory width, therefore arranging the surplus part of the line in a subsequent line, and further it is premised that the image data in the data memory is arranged in the field format, the foregoing address conversion enables the access in the frame format. In the foregoing manner, it is unnecessary to provide the program responding to the access formats, thereby reducing the code size. Further, it is unnecessary to rearrange the data, which leads to the reduction of the throughput.

5) The address conversion unit implements changeovers, with respect to the first bit, second bid, third bit, fourth bit and fifth bit from the lower order of the address data, to the arrangement state of the fifth bit, first bit, and second bit, third bit and fourth bit from the lower order, and to the arrangement state of the fifth bit, second bit, third bit, fourth bit and first bit from the lower side bit to thereby change the bit positions.

When 16 pixels are a unit per processing, and a line of the image data cannot be disposed in a line of the memory due to the limited memory width, therefore arranging the surplus part of the line in a position 16 lines below, and further it is premised that the image data in the data memory is arranged in the frame format, the foregoing address conversion enables the access in the field format. In the foregoing manner, it is unnecessary to provide the program responding to the access formats, thereby reducing the code size. Further, it is unnecessary to rearrange the data, which leads to the reduction of the throughput. Further, because it is unnecessary to provide an address conversion table, the required memory size is not increased.

6) The address conversion unit implements changeovers, with respect the first bit, second bid, third bit, fourth bit and fifth bit from the lower order of the address data, to the arrangement state of the fifth bit, fourth bit, first bit, second bit and third bit from the lower order, and to the arrangement state of the fifth bit, first bit, second bit, third bit and fourth bit from the lower order bit to thereby change the bit positions.

When 16 pixels are a unit per processing, and a line of the image data cannot be disposed in a line of the memory due to the limited memory width, therefore arranging the surplus part of the line in the position 16 lines below, and further it is premised that the image data in the data memory is arranged in the field format, the foregoing address conversion enables the access in the frame format. In the foregoing manner, it is unnecessary to provide the program responding to the access formats, thereby reducing the code size. Further, it is unnecessary to rearrange the data, which leads to the reduction of the throughput. Further, because it is unnecessary to provide the address conversion table, the required memory size is not increased.

7) The address conversion unit implements changeovers, with respect to the first bit, second bid, third bit, fourth bit and fifth bit from the lower order of the address data, to the arrangement state of the fourth bit, first bit, second bit, third bit and fifth bit from the lower order, and to the arrangement state of the fourth bit, second bit, third bit, fifth bit and first bit from the lower order bit to thereby change the bit positions.

When 16 pixels are a unit per processing, and a line of the image data cannot be disposed in a line of the memory due to the limited memory width, therefore arranging the surplus part of the line in a position eight lines below, and further it is premised that the image data in the data memory is arranged in the frame format, the foregoing address conversion enables the access in the field format. In the foregoing manner, it is unnecessary to provide the program responding to the access formats, thereby reducing the code size. Further, it is unnecessary to rearrange the data, which leads to the reduction of the throughput. Further, because it is unnecessary to provide the address conversion table, the required memory size is not increased.

8) The address conversion unit implements changeovers, with respect to the first bit, second bid, third bit, fourth bit and fifth bit from the lower order of the address data, to the arrangement state of the fourth bit, fifth bit, first bit, second bit and third bit from the lower order, and to the arrangement state of the fourth bit, first bit, second bit, third bit and fifth bit from the lower side bit to thereby change the bit positions.

When 16 pixels are a unit per processing, and a line of the image data cannot be disposed in a line of the memory due to the limited memory width, therefore arranging a surplus part of the line in the position eight lines below, and further it is premised that the image data in the data memory is arranged in the field format, the foregoing address conversion enables the access in the frame format. In the foregoing manner, it is unnecessary to provide the program responding to the access formats, thereby reducing the code size. Further, it is unnecessary to rearrange the data, which leads to the reduction of the throughput. Further, because it is unnecessary to provide the address conversion table, the required memory size is not increased.

Both of the address conversion units in 1) and 2) may be provided, each used for a different purpose according to need. At least two or more from any of the plurality of address conversion units in 3)-8) may be provided, each used for a different purpose according to need.

A second parallel operation apparatus of the SIMD type according to the present invention comprises, a SIMD-type processor element group including a plurality of processor elements, wherein the respective processor elements simultaneously execute an identical operation, a data memory accessible from the respective processor elements, and a data changeover unit for negating a read request for an address which does not fall under conditions and inputting fixed data to the processor elements.

In the second SIMD-type parallel operation apparatus, CBP is used to judge whether or not blocks in a macro block are respectively encoded in the case of MPEG. When a CBP value is “0” meaning that the relevant block is not encoded, all of encoding data is “0”, which makes it unnecessary to read data. In the case of the read request for the address, which does not fall under the conditions, for example, when the CBP value is “0”, the data changeover unit negates the request and inputs the fixed data to the processor elements. In the foregoing manner, the read of the unnecessary data, which does not fall under the conditions, is halted by means of the address value, so that any unnecessary access to the memory can be eliminated, reducing the power consumption. Further, because the program does not judge whether or not the data is necessary, the program can be prevented from being complicated.

### BRIEF DESCRIPTION OF THE DRAWINGS

The present invention is illustrated by way of example and not limitation in the figures of the accompanying drawings, in which like references indicate similar elements and in which:

FIG. 1 illustrates a configuration of a parallel operation apparatus of a SIMD type according to embodiments 1 through 8 of the present invention.

FIG. 2 illustrates a configuration of an address conversion unit according to the embodiment 1.

FIG. 3 shows an operation of the address conversion unit according to the embodiment 1.

FIG. 4 is a memory map in the case of an image comprised of horizontal eight pixels×vertical eight pixels each having 16 bits and arranged in a frame format according to the embodiment 1.

FIG. 5 illustrates a configuration of an address conversion unit according to the embodiment 2.

FIG. 6 shows an operation of the address conversion unit according to the embodiment 2.

FIG. 7 is a memory map in the case of an image comprised of horizontal eight pixels×vertical eight pixels each having 16 bits and arranged in a field format according to the embodiment 2.

FIG. 8 illustrates a configuration of an address conversion unit according to the embodiment 3.

FIG. 9 shows an operation of the address conversion unit according to the embodiment 3.

FIG. 10 is a memory map in the case of an image comprised of horizontal 16 pixels×vertical 16 pixels each having 16 bits and arranged in the frame format according to the embodiment 3.

FIG. 11 is a relationship diagram of the memory map according to the embodiment 3 and a spatial image.

FIG. 12 illustrates a configuration of an address conversion unit according to the embodiment 4.

FIG. 13 shows an operation of the address conversion unit according to the embodiment 4.

FIG. 14 is a memory map in the case of an image comprised of horizontal 16 pixels×vertical 16 pixels each having 16 bits and arranged in the field format according to the embodiment 4.

FIG. 15 illustrates a configuration of an address conversion unit according to the embodiment 5.

FIG. 16 shows an operation of the address conversion unit according to the embodiment 5.

FIG. 17 is a memory map in the case of an image comprised of horizontal 16 pixels×vertical 16 pixels each having 16 bits and arranged in the frame format according to the embodiment 5.

FIG. 18 is a relationship diagram of the memory map according to the embodiment 5 and a spatial image.

FIG. 19 illustrates a configuration of an address conversion unit according to the embodiment 6.

FIG. 20 shows an operation of the address conversion unit according to the embodiment 6.

FIG. 21 is a memory map in the case of an image comprised of horizontal 16 pixels×vertical 16 pixels each having 16 bits and arranged in the field format according to the embodiment 6.

FIG. 22 illustrates a configuration of an address conversion unit according to the embodiment 7.

FIG. 23 shows an operation of the address conversion unit according to the embodiment 7.

FIG. 24 is a memory map in the case of an image comprised of horizontal 16 pixels×vertical 16 pixels each having 16 bits and arranged in the frame format according to the embodiment 7.

FIG. 25 is a relationship diagram of the memory map according to the embodiment 7 and a spatial image.

FIG. 26 illustrates a configuration of an address conversion unit according to the embodiment 8.

FIG. 27 shows an operation of the address conversion unit according to the embodiment 8.

FIG. 28 is a memory map in the case of an image comprised of horizontal 16 pixels×vertical 16 pixels each having 16 bits and arranged in the field format according to the embodiment 8.

FIG. 29 illustrates a configuration of a parallel operation apparatus of the SIMD type according to an embodiment 9 of the present invention.

FIG. 30 is an illustration of a bit configuration of CBP.

FIG. 31 shows a conversion table for an inputted address according to the embodiment 9.

FIG. 32 illustrates a configuration of a parallel operation apparatus of the SIMD type according to an embodiment 10 of the present invention.

FIG. 33A is an illustration of the frame format.

FIG. 33B is an illustration of the field format.

FIG. 34 illustrates a configuration of a parallel operation apparatus of the SIMD type according to a patent literature 1.

FIG. 35 illustrates a configuration of a processor element according to a patent literature 1.

FIG. 36 illustrates a data address conversion circuit according to the patent literature 1.

FIG. 37A shows a data address storage memory in the frame format according to a conventional technology.

FIG. 37B shows a data address storage memory in the field format according to the conventional technology.

FIG. 38A shows an operation of a rotating circuit in the frame format according to the conventional technology.

FIG. 38B shows an operation of the rotating circuit in the field format according to the conventional technology.

### DESCRIPTION OF THE PREFERRED EMBODIMENTS OF THE INVENTION

Hereinafter, a parallel operation apparatus of a SIMD type according to preferred embodiments of the present invention is described referring to the drawings.

### Embodiment 1

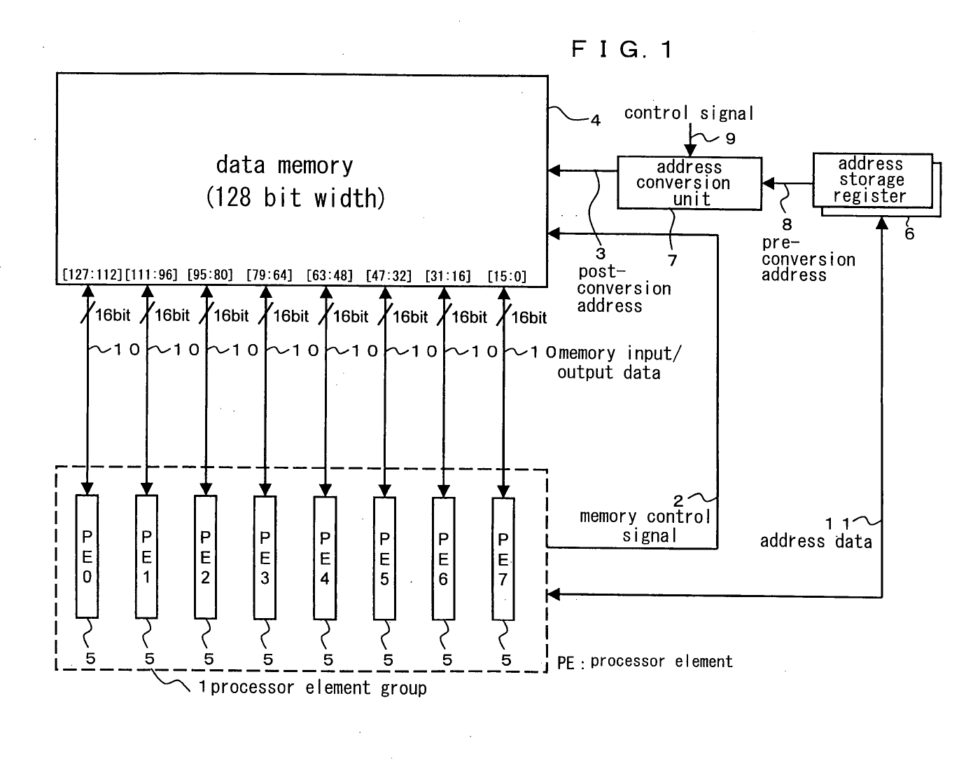

FIG. 1 illustrates a configuration of a parallel operation apparatus of a SIMD type according to an embodiment 1 of the present invention. A reference numeral 1 denotes a processor element group constituting an operation unit of the SIMD type by means of a plurality of processor elements 5. The processor element group 1 outputs a read request to a memory control signal 2 to thereby read data in a position indicated by a post-conversion address 3 at that time from a data memory 4. The processor element group 1 further executes a processing, and outputs a write request to the memory control signal 2 to thereby write a result in a position indicated by the post-conversion address 3 at that time. In the processor element group 1 of the SIMD type, the respective processor elements 5 simultaneously execute an identical processing. More specifically, the respective processor elements 5 are configured in such manner as fetching pixel values of an image signal in a horizontal period (equivalent to a line) into a memory circuit to thereby programmably simultaneously execute the identical processing to the respective pixels by means of an operation circuit corresponding to each pixel value.

Input and output data of the processor elements 5 is stored in the data memory 4. The data memory 4 is evenly allocated to the processor elements 5. A pre-conversion address 8 to be inputted to an address conversion unit 7 is stored in an address storage register 6, and a value of the pre-conversion address 8 can be controlled by means of the processor element group 1. There may be a plurality of address storage registers 6. An address conversion unit 7 converts the pre-conversion address 8 from the address storage register 6 and creates the post-conversion address 3. The address conversion unit 7 changes over a conversion method in response to an external control signal.

An operation of the SIMD-type parallel operation apparatus in writing with respect to the data memory 4 is described. The processor element group 1 outputs the write request to the memory control signal 2. The data memory 4 receives the write request, and stores the data outputted from the respective processor elements 5 in a position indicated by the post-conversion address 3 resulting from the conversion of the pre-conversion 8 by the address conversion unit 7.

An operation of the SIMD-type parallel operation apparatus in reading with respect to the data memory 4 is described. The processor element group 1 outputs the read request to the memory control signal 2. The data memory 4 receives the read request, and outputs the data in a position indicated by the post-conversion address 3 resulting from the conversion of the pre-conversion 8 by the address conversion unit 7.

In the case where serial addresses are inputted to the address conversion unit 7, a value of the address storage register 6 is incremented by one by the processor element group 1 for each read or write.

In FIG. 1, a width of the data memory 4 is 128 bits, and the number of the processor elements 5 is eight to describe the operation, however, they are not necessarily limited thereto.

In the address conversion unit 7, a bit order of an address value is changed to thereby convert serial accesses into an effective access order so that the foregoing problem is solved. An operation of the bit order change is changed over by means of an external control signal 9.

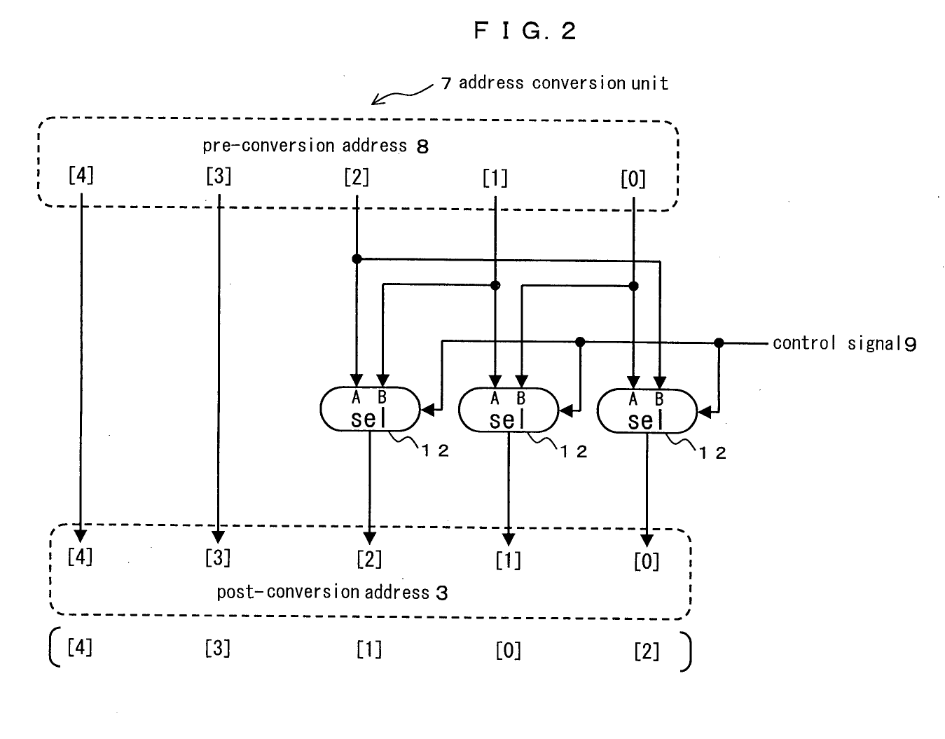

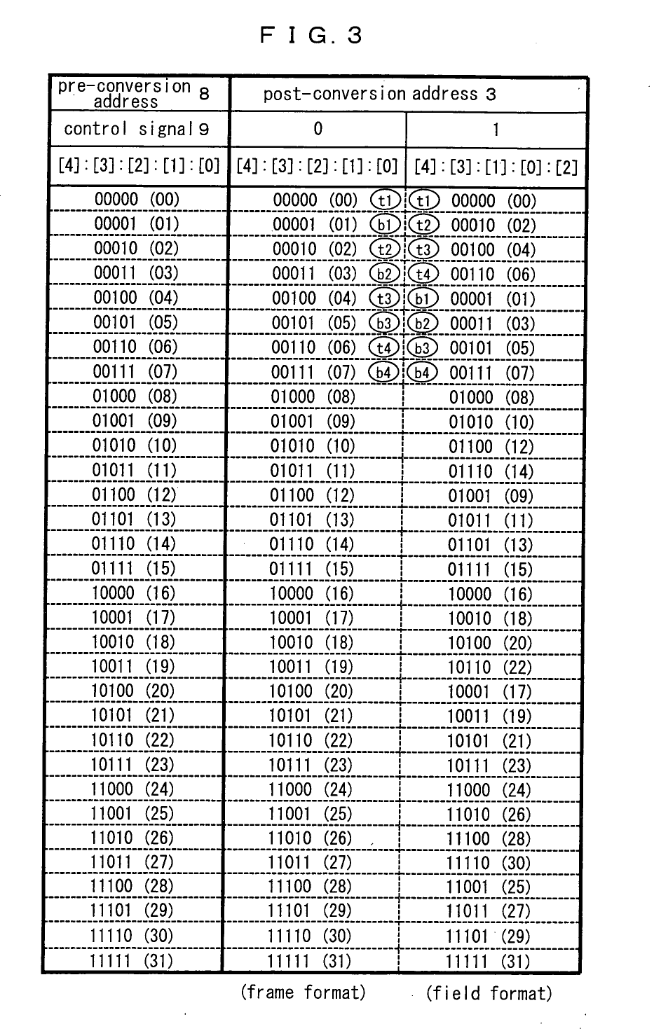

FIG. 2 illustrates a configuration of the address conversion unit 7 according to the embodiment 1. In FIG. 2, address conversion selectors 12 operate in such manner as selecting “A” when the control signal 9 is “0”, and selecting “B” when the control signal 9 is “1”. FIG. 3 shows an operation of the address conversion unit 7 in that case.

In FIG. 3, the second row shows values of the control signal 9, while the third row shows methods of changing the bit order. Here, [i] (I=0-4) indicates a (i+1)th bit from the low order of the pre-conversion address 8. Providing a description referring to the case where the control signal of FIG. 3 is “1”, the third bit “[2]” from the low order of the pre-conversion address 8 is disposed in the first bit in the lowest order, the first bit “[0]” is disposed in the second bit, and the second bit “[1]” is disposed in the third bit to thereby convert the address.

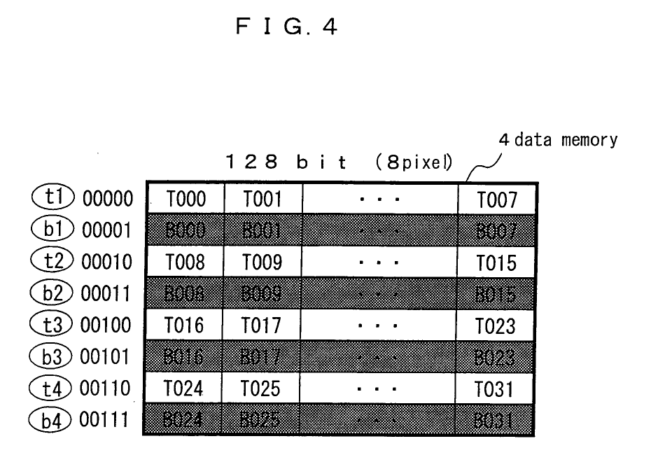

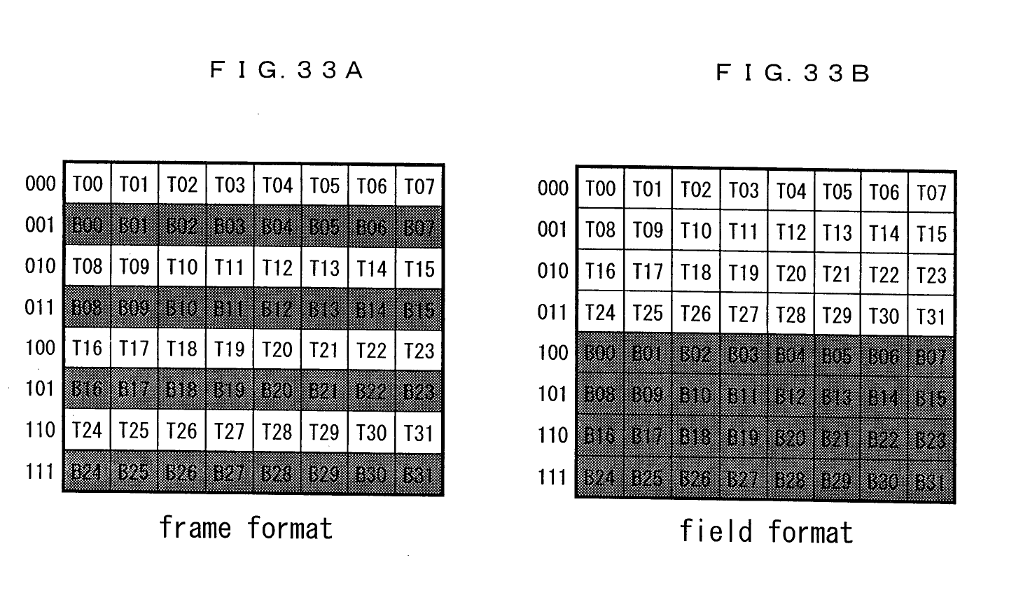

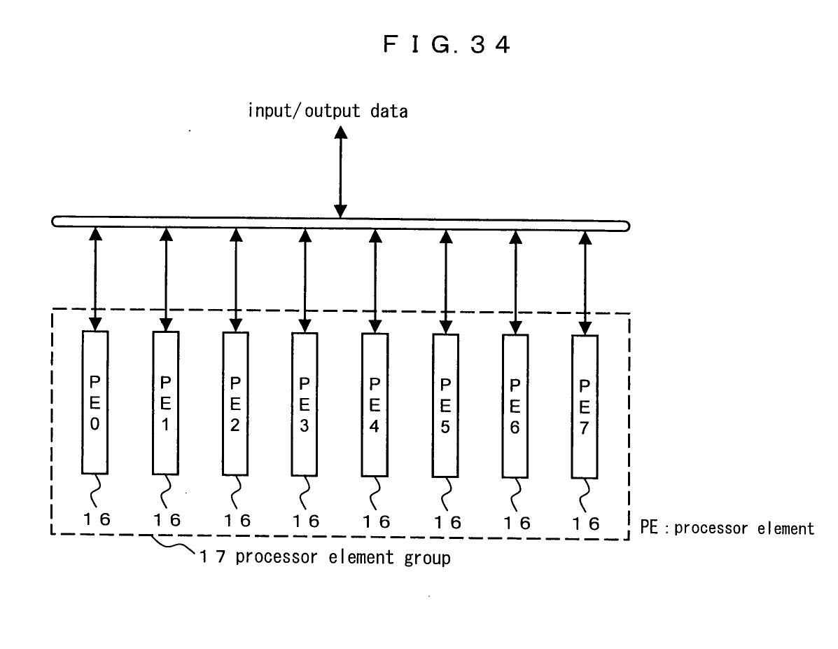

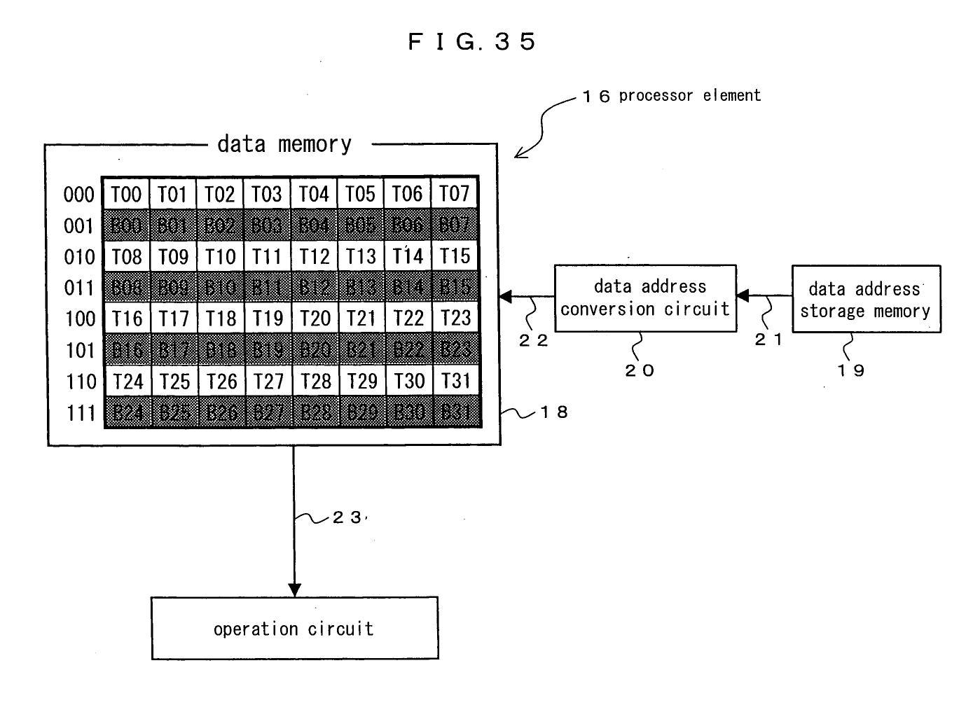

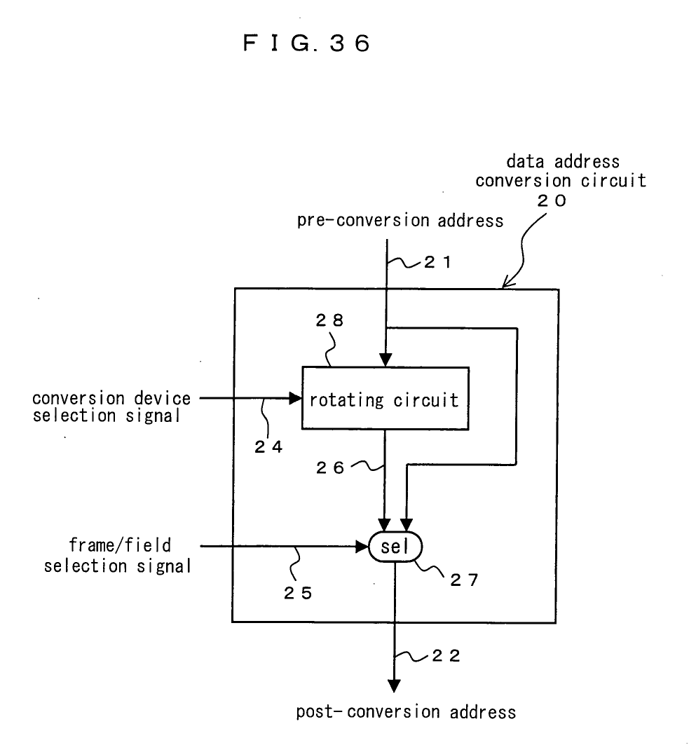

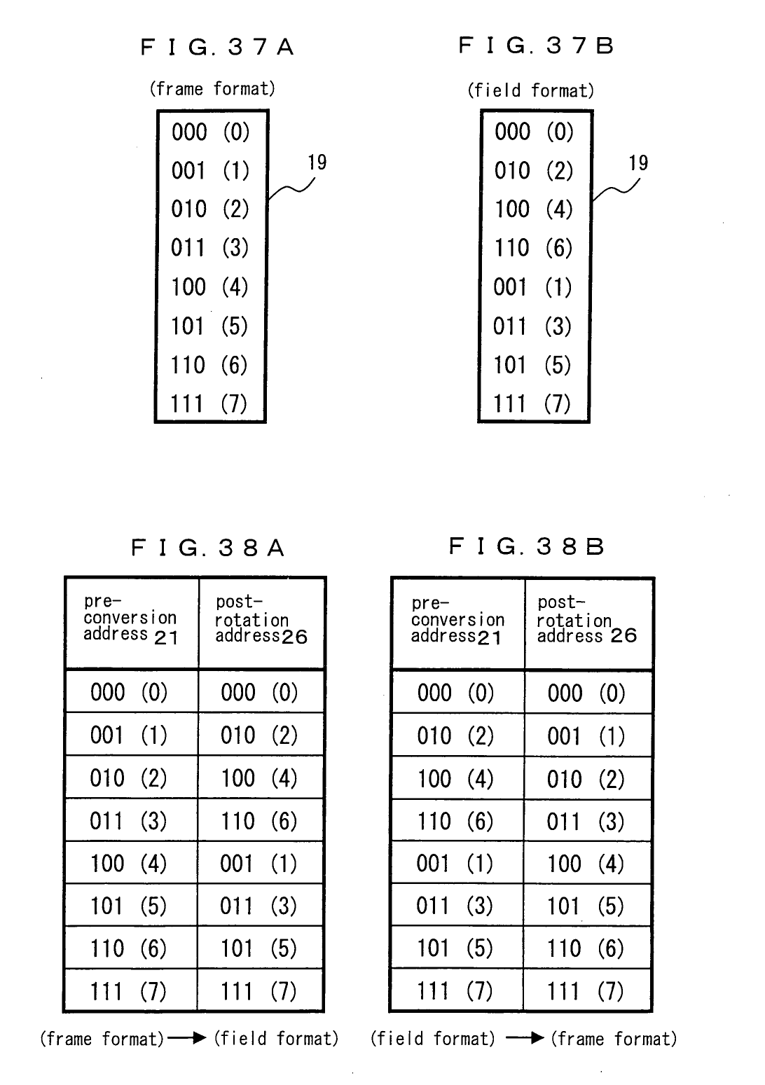

FIG. 4 shows the case where an image comprised of horizontal eight pixels×vertical eight pixels each having 16 bits is disposed in the data memory 4 in the frame format. In the foregoing case, providing that the serial addresses are supplied to the address storage register 6 and the conversion operation shown in FIG. 3 is followed, the control signal 9 is set to “1”. By doing so, the serial addresses are converted into an effective address order, and the post-conversion addresses 3 are used to thereby execute the read. Thus, the image can be obtained in the field format shown in FIG. 33B.

Further, when the control signal 9 is set to “0”, the image can be obtained in the frame format shown in FIG. 33A.

Below is provided a more specific description. In FIG. 3, address reference symbols t1, b1, t2, b2, t3, b3, t4, and b4 are shown in the first through the eighth rows in the method of changing the bit order when the control signal 9 is “0”. The address reference symbols correspond to the frame format shown in FIG. 4. The address reference symbols are converted into the field format when the control signal 9 is “1”, as t1, t2, t3, t4, b1, b2, b3, and b4.

As described, according to the present embodiment, no program or data rearrangement responding to the respective frame and field formats is necessary. The image can be obtained in either frame format or field format by changing over the control signal 9.

### Embodiment 2

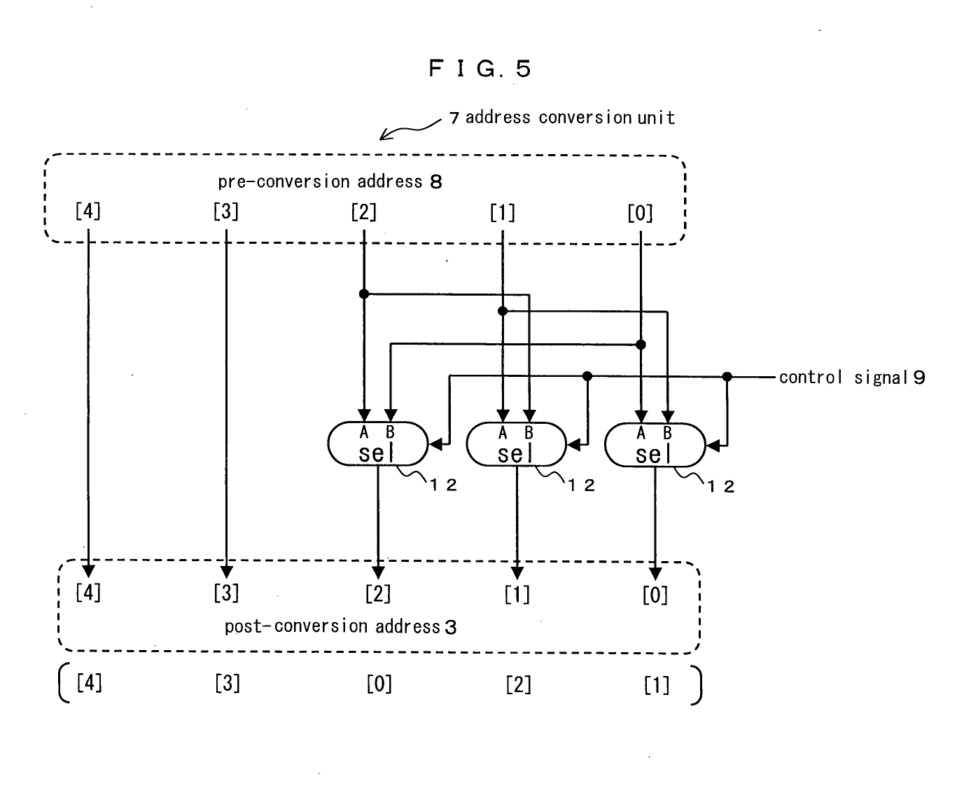

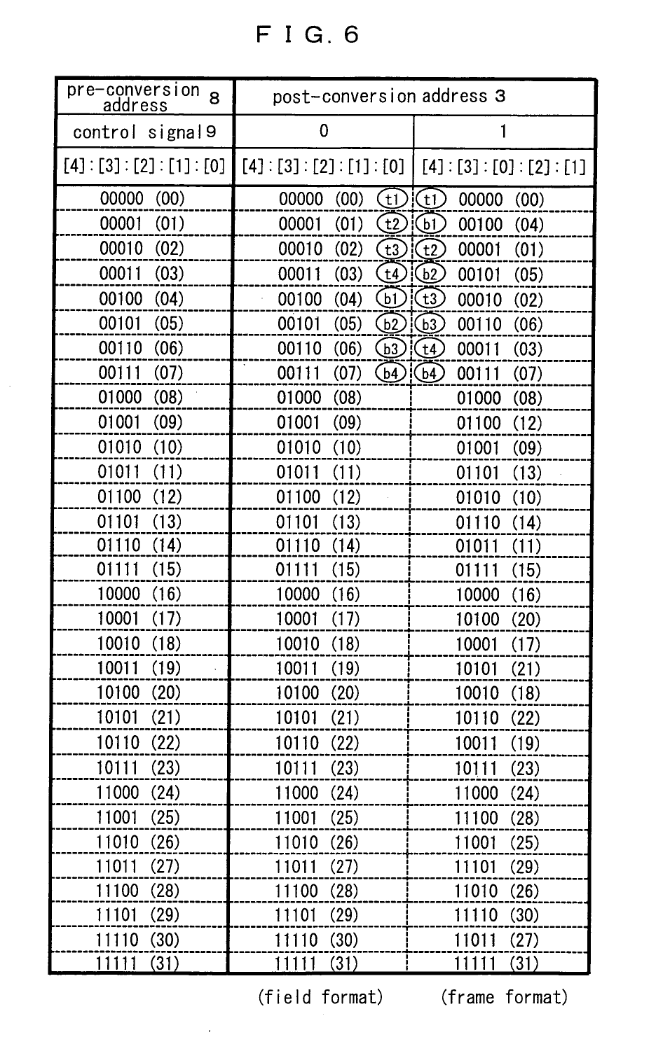

A configuration of a parallel operation apparatus of the SIMD type according to an embodiment 2 of the present invention is the same as the configuration shown in FIG. 1 according to the embodiment 1, except for the configuration of the address conversion unit 7. FIG. 5 illustrates a configuration of an address conversion unit 7 according to the embodiment 2. FIG. 6 shows an operation of the address conversion unit 7.

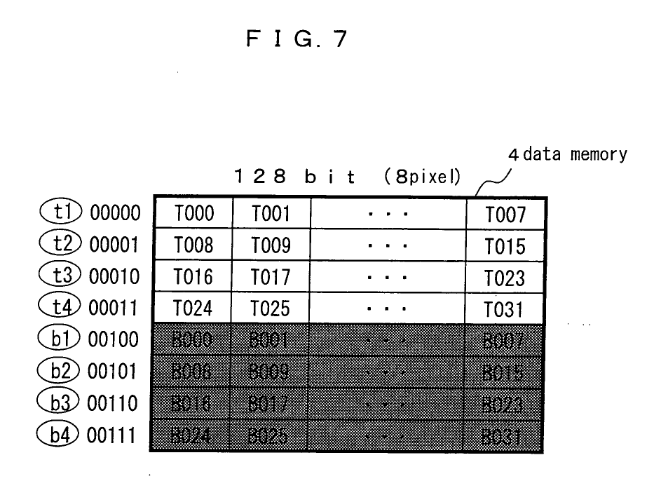

FIG. 7 shows the case where an image comprised of horizontal eight pixels×vertical eight pixels each having 16 bits is disposed in the data memory 4 in the field format.

In the foregoing case, providing that the serial addresses are supplied to the address conversion register 6 and the conversion operation shown in FIG. 6 is followed, the control signal 9 is set to “1”. By doing so, the serial addresses are converted into the effective address order, and the post-conversion addresses 3 are used to thereby execute the read. Thus, the image can be obtained in the frame format.

Further, when the control signals 9 is set to “0”, the image can be obtained in the field format.

Below is provided a more specific description. In FIG. 6, address reference symbols t1, t2, t3, t4, b1, b2, b3 and b4 are shown in the first through the eighth rows in the method of changing the bit order when the control signal 9 is “0”. The address reference symbols correspond to the field format shown in FIG. 7. The address reference symbols are converted into the frame format when the control signal 9 is “1”, as t1, b1, t2, b2, t3, b3, t4 and b4.

As described, according to the present embodiment, no program or data rearrangement responding to the respective frame and field formats is necessary. The image can be obtained in either frame format or field format by changing over the control signal 9.

### Embodiment 3

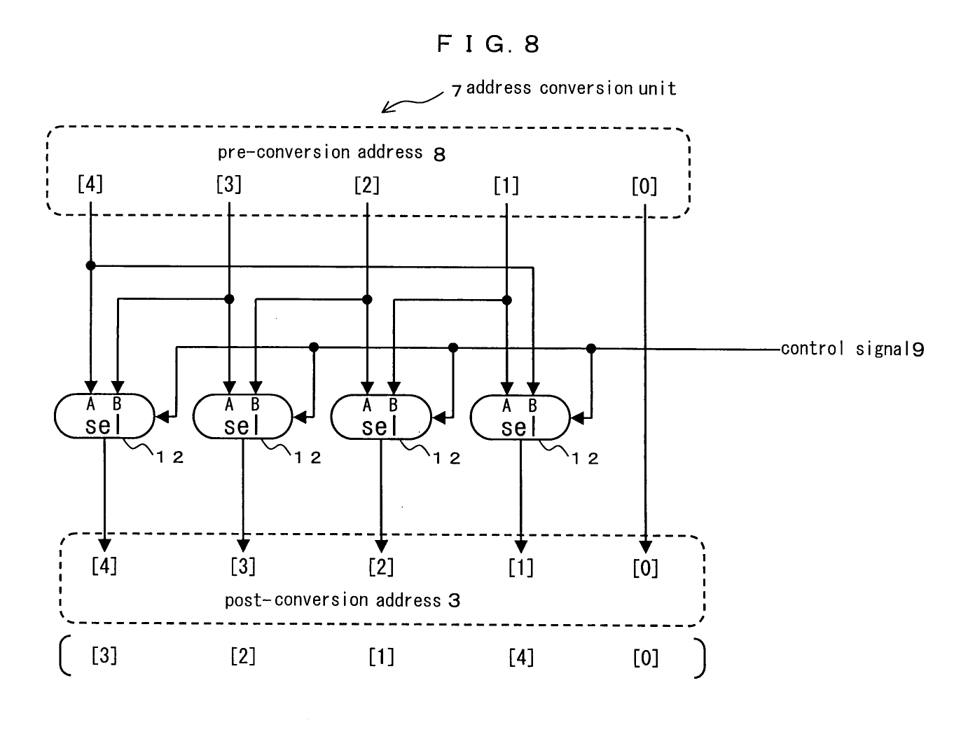

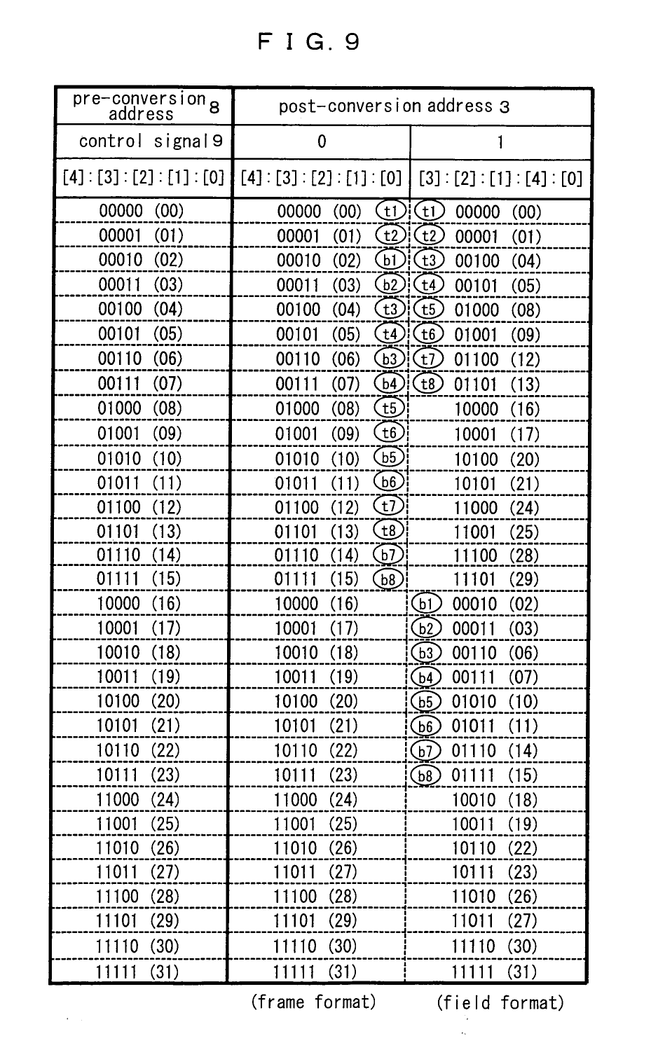

A configuration of a parallel operation apparatus of the SIMD type according to an embodiment 3 of the present invention is the same as the configuration shown in FIG. 1 according to the embodiment 1, except for the configuration of the address conversion unit 7. FIG. 8 illustrates a configuration of an address conversion unit 7 according to the embodiment 3. FIG. 9 shows an operation of the address conversion unit 7.

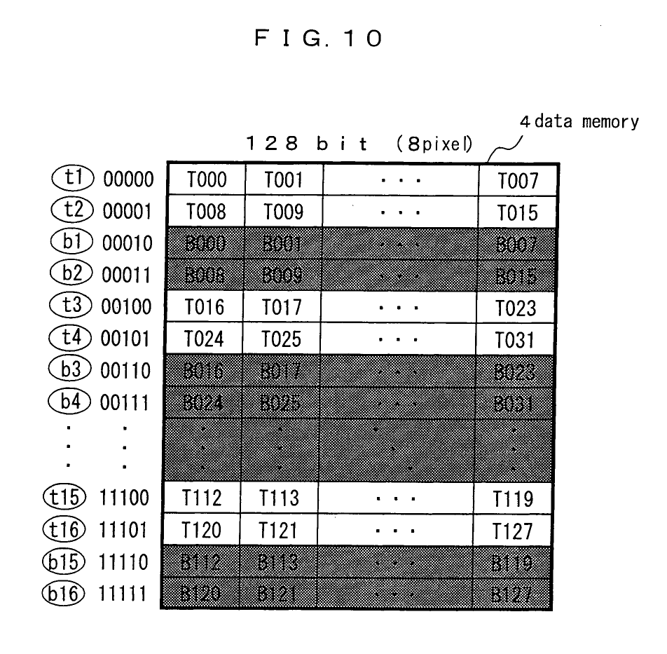

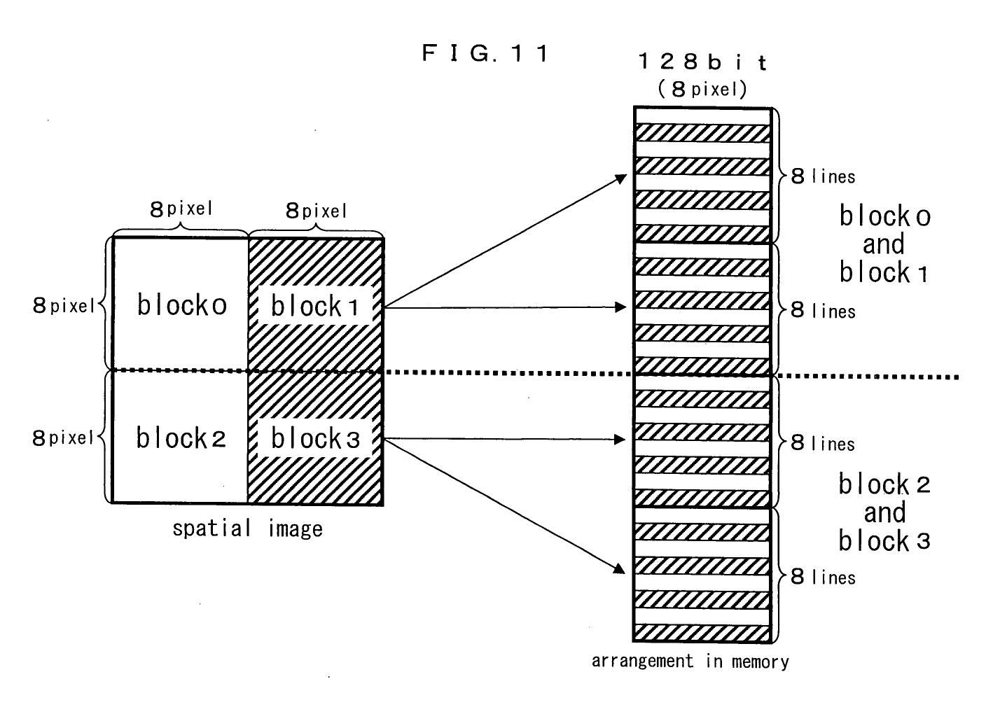

FIG. 10 shows the case where an image comprised of horizontal 16 pixels×vertical 16 pixels each having 16 bits is disposed in the data memory 4 in the frame format. A line of the image cannot be disposed in a line of the memory, therefore arranging a surplus part of the line in a subsequent line. FIG. 11 illustrates a relationship between the image and image arrangement in the memory.

In the foregoing case, providing that the serial addresses are given to the address storage register 6 and the conversion operation shown in FIG. 9 is followed, the control signal 9 is set to “1”. By doing so, the serial addresses are converted into the effective address order, and the post-conversion addresses 3 are used to thereby execute the read. Thus, the image can be obtained in the field format though it is necessary to execute the read twice with respect to a line of the image in such manner that left-side eight pixels of a line of the image are read in the first read, and right-side eight pixels of the line of the image are read in the next read.

Further, the image can be obtained in the frame format by setting the control signal 9 to “0”.

Below is provided a description in more detail. In FIG. 9, address reference symbols t1, t2, b1, b2, t3, t4, b3, b4, t5, t6, b5, b6, t7, t8, b7, b8 . . . are shown in the first through the 16th rows in the method of changing the bit order when the control signal 9 is “0”. The address reference symbols correspond to the frame format in FIG. 10. The address reference symbols are converted into the field format when the control signal 9 is “1”, as t1, t2, t3, t4, t5, t6, t7, t8 . . . b1, b2, b3, b4, b5, b6, b7, b8 . . . .

As described, according to the present embodiment, no program or data rearrangement responding to the respective frame and field formats is necessary. The image can be obtained in either frame format or field format by changing over the control signal 9.

### Embodiment 4

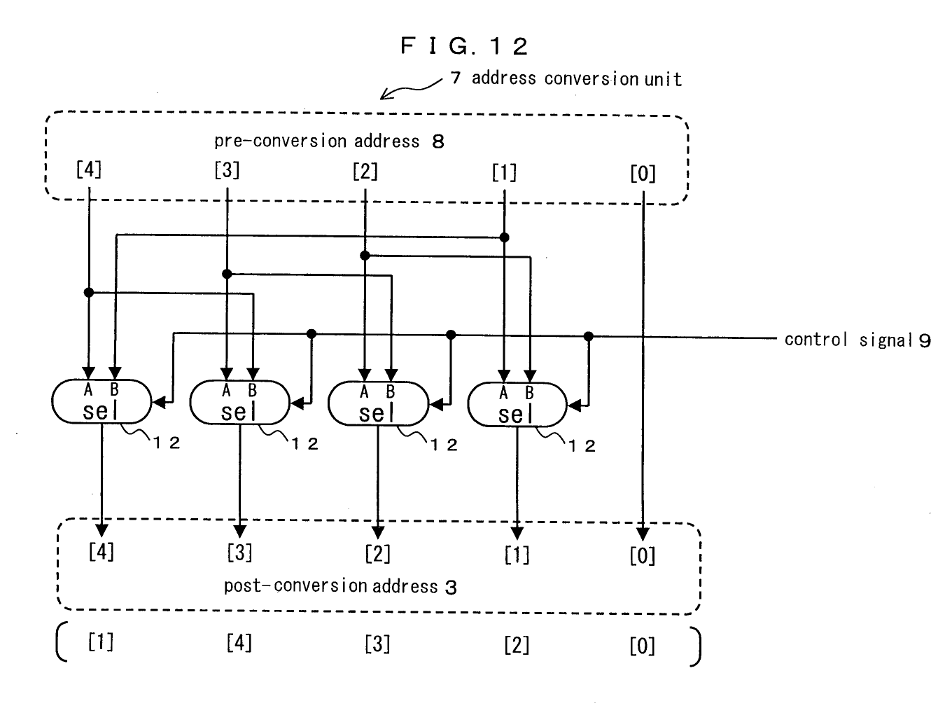

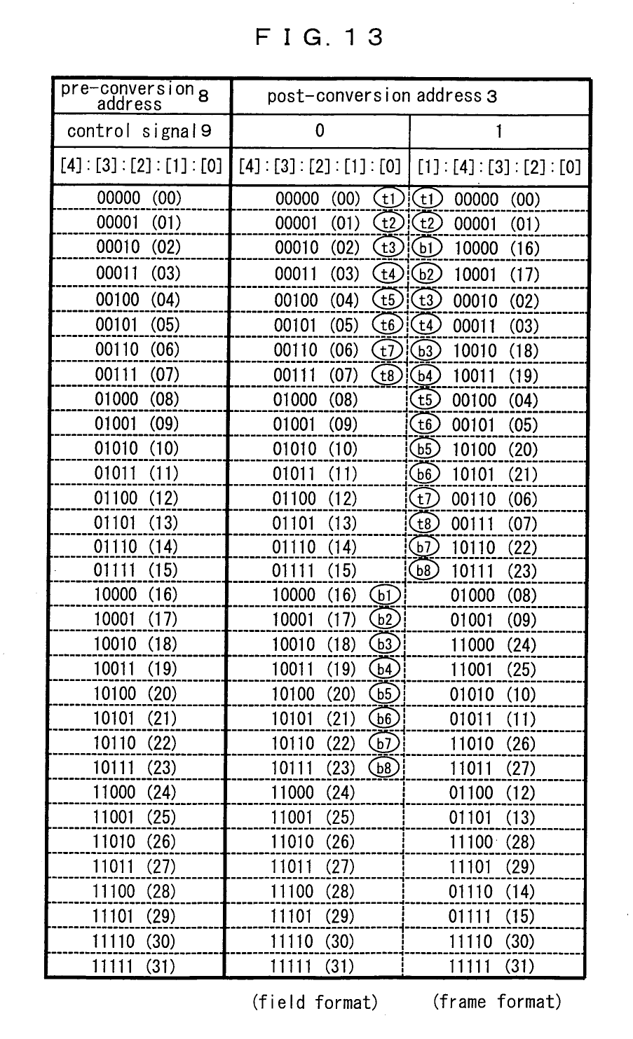

A configuration of a parallel operation apparatus of the SIMD type according to an embodiment 4 of the present invention is the same as the configuration shown in FIG. 1 according to the embodiment 1, except for the configuration of the address conversion unit 7. FIG. 12 illustrates a configuration of an address conversion unit 7 according to the embodiment 4. FIG. 13 shows an operation of the address conversion unit 7.

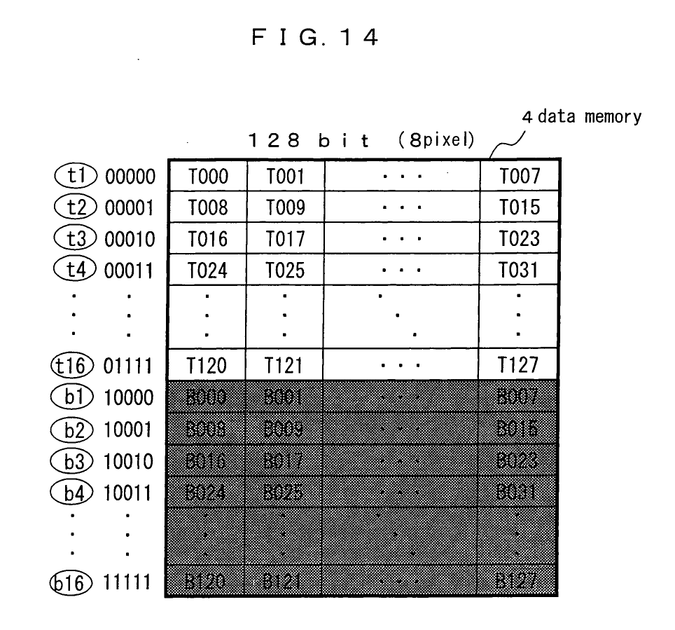

FIG. 14 shows the case where an image comprised of horizontal 16 pixels×vertical 16 pixels each having 16 bits is disposed in the data memory 4 in the field format. A line of the image cannot be disposed in a line of the memory, therefore arranging a surplus part of the line in a subsequent line.

In the foregoing case, providing that the serial addresses are given to the address storage register 6 and the conversion operation shown in FIG. 13 is followed, the control signal 9 is set to “1”. By doing so, the serial addresses are converted into the effective address order, and the post-conversion addresses 3 are used to thereby execute the read. Thus, the image can be obtained in the frame format though it is necessary to execute the read twice with respect to a line of the image in such manner that left-side eight pixels of a line of the image are read in the first read, and right-side eight pixels of the line of the image are read in the next read.

Further, the image can be obtained in the field format by setting the control signal 9 to “0”.

Below is provided a description in more detail. In FIG. 13, address reference symbols t1, t2, t3, t4, t5, t6, t7, t8 . . . b1, b2, b3, b4, b5, b6, b7, b8 . . . are shown in the method of changing the bit order when the control signal 9 is “0”. The address reference symbols correspond to the field format shown in FIG. 14. The address reference symbols are converted into the frame format when the control signal 9 is “1”, as t1, t2, b1, b2, t3, t4, b3, b4, t5, t6, b5, b6, t7, t8, b7, b8 . . . .

As described, according to the present embodiment, no program or data rearrangement responding to the respective frame and field formats is necessary. The image can be obtained in either frame format or field format by changing over the control signal 9.

### Embodiment 5

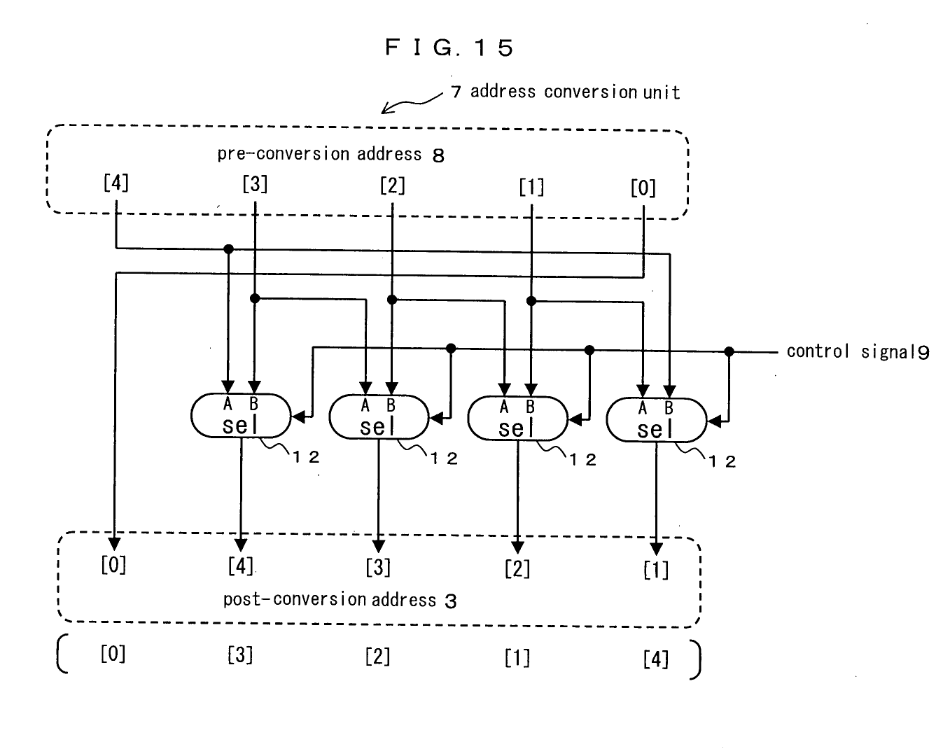

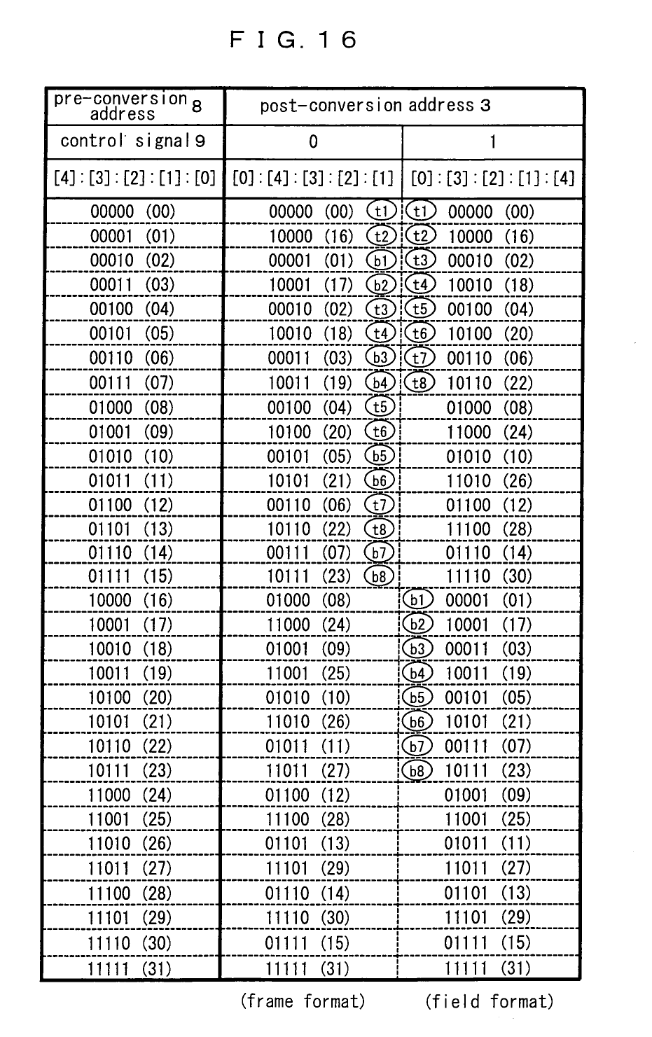

A configuration of a parallel operation apparatus of the SIMD type according to an embodiment 5 of the present invention is the same as the configuration shown in FIG. 1 according to the embodiment 1, except for the configuration of the address conversion unit 7. FIG. 15 illustrates a configuration of an address conversion unit 7 according to the embodiment 5. FIG. 16 shows an operation of the address conversion unit 7.

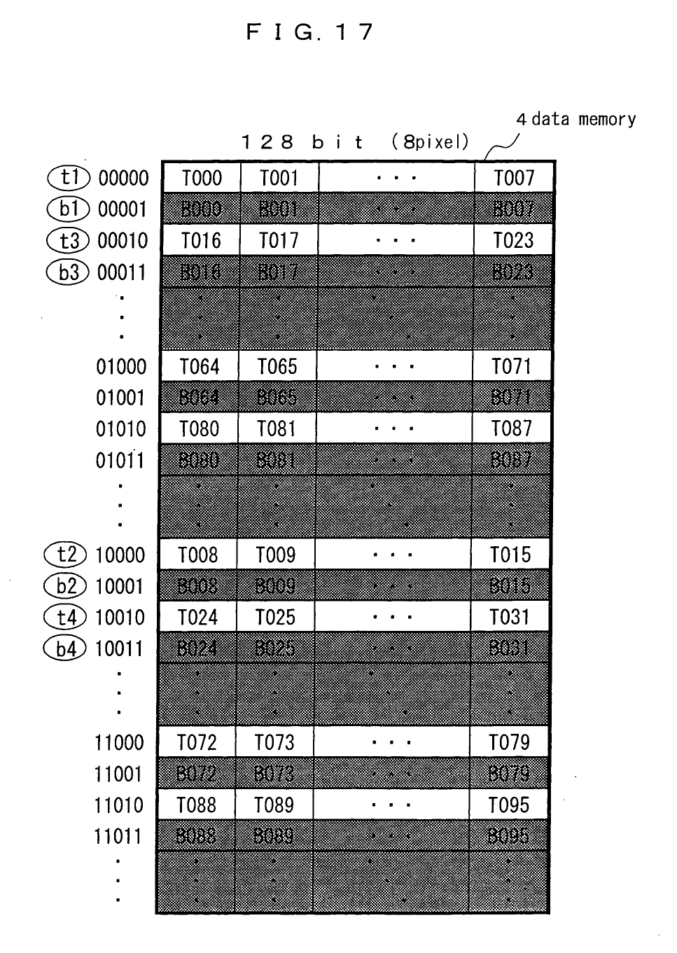

FIG. 17 shows the case where an image comprised of horizontal 16 pixels×vertical 16 pixels each having 16 bits is disposed in the data memory 4 in the frame format. A line of the image cannot be disposed in a line of the memory, therefore arranging a surplus part of the line in a position 16 lines below.

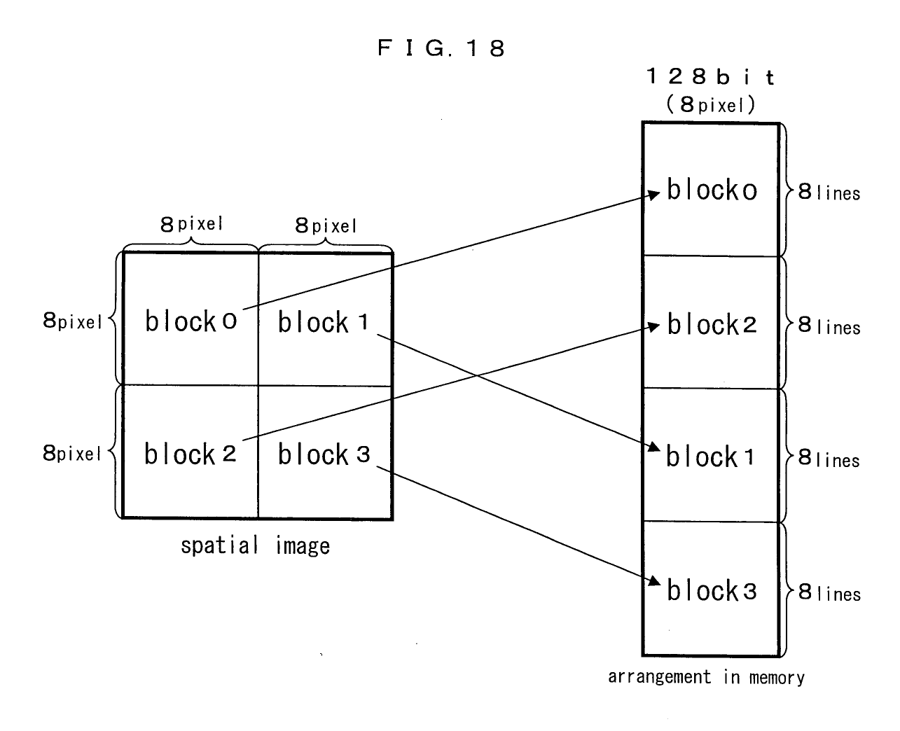

FIG. 18 illustrates a relationship between the image and image arrangement in the memory. When the image data having a width larger than the width of the memory is disposed in the memory, it becomes necessary to issue a DMA instruction twice due to the performance of DMA. In such a case, the foregoing arrangement is often employed.

In the foregoing case, providing that the serial addresses are given to the address storage register 6 and the conversion operation shown in FIG. 16 is followed, the control signal 9 is set to “0”. By doing so, the serial addresses are converted into the effective address order, and the post-conversion addresses 3 are used to thereby execute the read. Thus, the image can be obtained in the frame format though it is necessary to execute the read twice with respect to a line of the image in such manner that left-side eight pixels of a line of the image are read in the first read, and right-side eight pixels of the line of the image are read in the next read.

Further, the image can be obtained in the field format by setting the control signal 9 to “1”.

Below is provided a description in more detail. In FIG. 16, address reference symbols t1, t2, b1, b2, t3, t4, b3, b4, t5, t6, b5, b6, t7, t8, b7, b8 . . . are shown in the method of changing the bit order when the control signal 9 is “0”. The address reference symbols are obtained by converting the frame format t1, b1, t3, b3 . . . t2, b2, t4, b4 . . . , which is shown in FIG. 17, and are still arranged in the frame format. The address reference symbols are converted into the field format when the control signal 9 is “1”, as t1, t2, t3, t4, t5, t6, t7, t8 b1, b2, b3, b4, b5, b6, b7, b8 . . . .

As described, according to the present embodiment, no program or data rearrangement responding to the respective frame and field formats is necessary. The image can be obtained in either frame format or field format by changing over the control signal 9.

### Embodiment 6

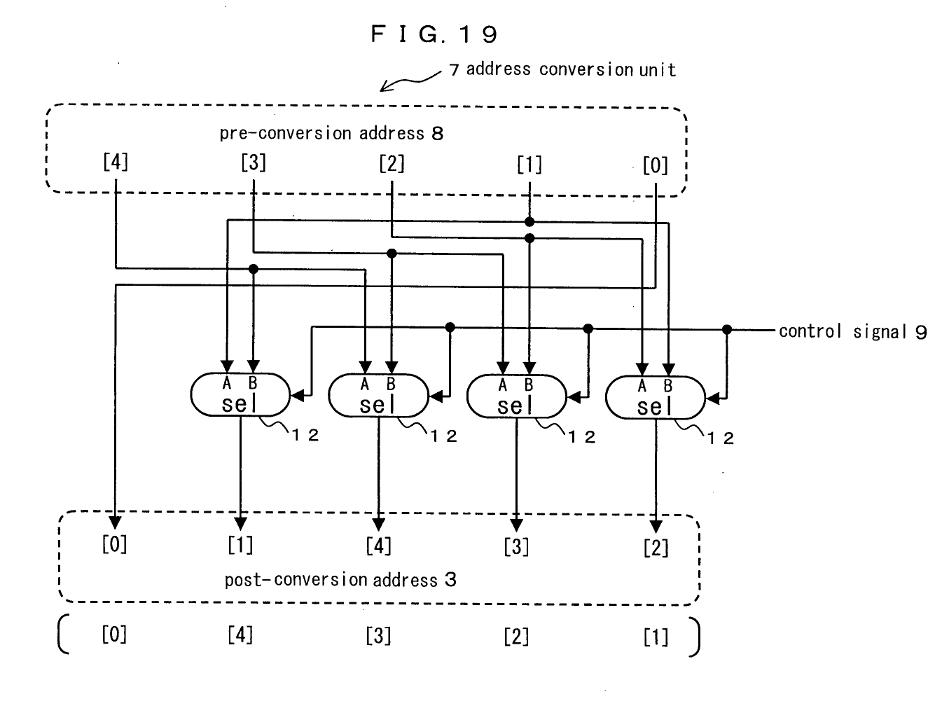

A configuration of a parallel operation apparatus of the SIMD type according to an embodiment 6 of the present invention is the same as the configuration shown in FIG. 1 according to the embodiment 1, except for the configuration of the address conversion unit 7. FIG. 19 illustrates a configuration of an address conversion unit 7 according to the embodiment 6. FIG. 20 shows an operation of the address conversion unit 7.

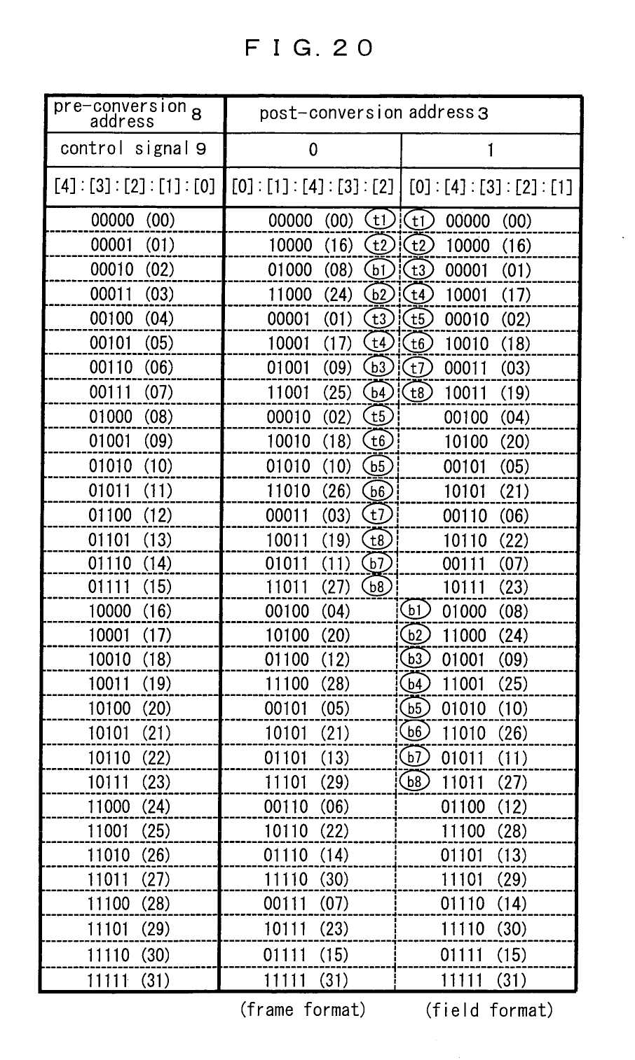

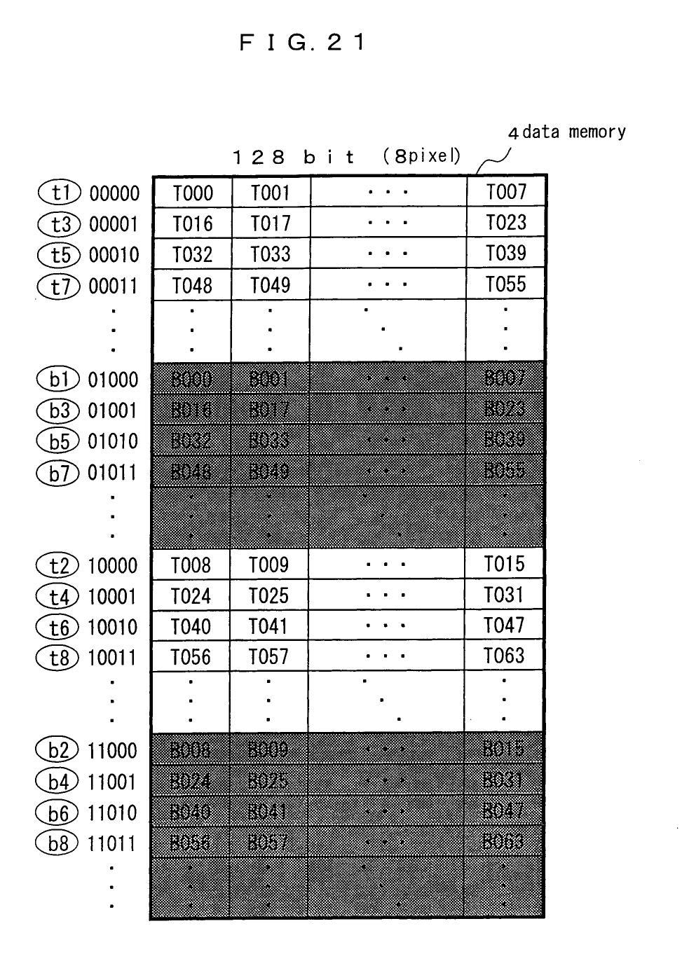

FIG. 21 shows the case where an image comprised of horizontal 16 pixels×vertical 16 pixels each having 16 bits is disposed in the data memory 4 in the field format. A line of the image cannot be disposed in a line of the memory, therefore arranging a surplus part of the line in a position 16 lines below.

In the foregoing case, providing that the serial addresses are given to the address storage register 6 and the conversion operation shown in FIG. 20 is followed, the control signal 9 is set to “0”. By doing so, the serial addresses are converted into the effective address order, and the post-conversion addresses 3 are used to thereby execute the read. Thus, the image can be obtained in the frame format though it is necessary to execute the read twice with respect to a line of the image in such manner that left-side eight pixels of a line of the image are read in the first read, and right-side eight pixels of the line of the image are read in the second read.

Further, the image can be obtained in the field format by setting the control signal 9 to “1”.

Below is provided a description in more detail. In FIG. 20, address reference symbols t1, t2, b1, b2, t3, t4, b3, b4, t5, t6, b5, b6, t7, t8, b7, b8 . . . are shown in the method of changing the bit order when the control signal 9 is “0”. The address reference symbols are obtained by converting the field format t1, t3, t5, t7 . . . b1, b3, b5, b7, . . . t2, t4, t6, t8 . . . b2, b4, b6, b8 . . . which is shown in FIG. 21, into the frame format. The address reference symbols are converted into the field format when the control signal 9 is “1”, as t1, t2, t3, t4, t5, t6, t7, t8 . . . b1, b2, b3, b4, b5, b6, b7, b8 . . . .

As described, according to the present embodiment, no program or data rearrangement responding to the respective frame and field formats is necessary. The image can be obtained in either frame format or field format by changing over the control signal 9.

### Embodiment 7

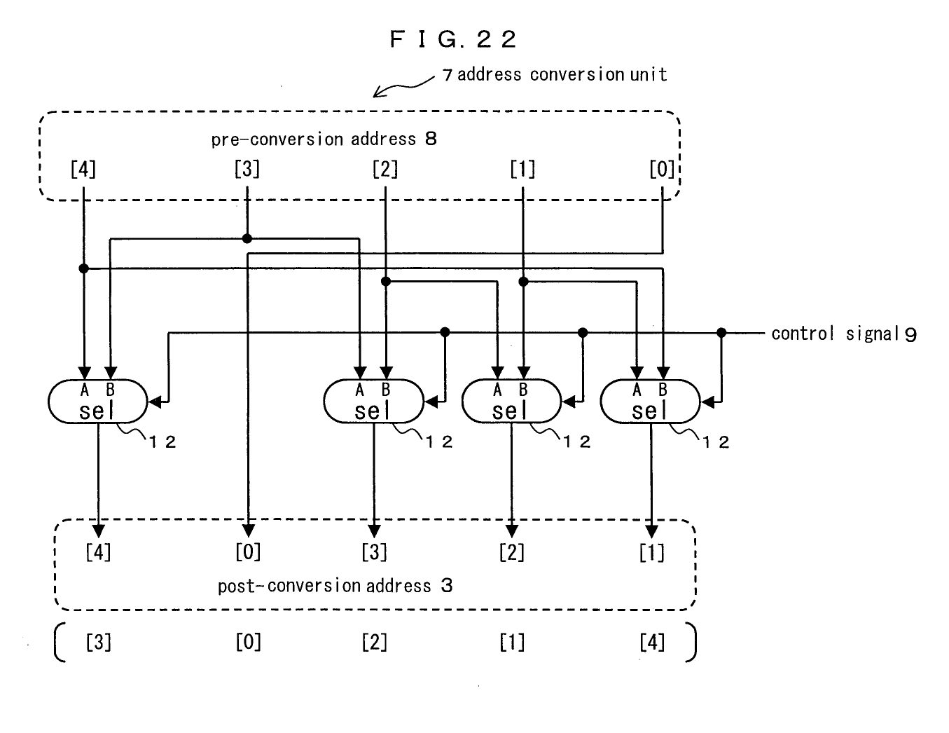

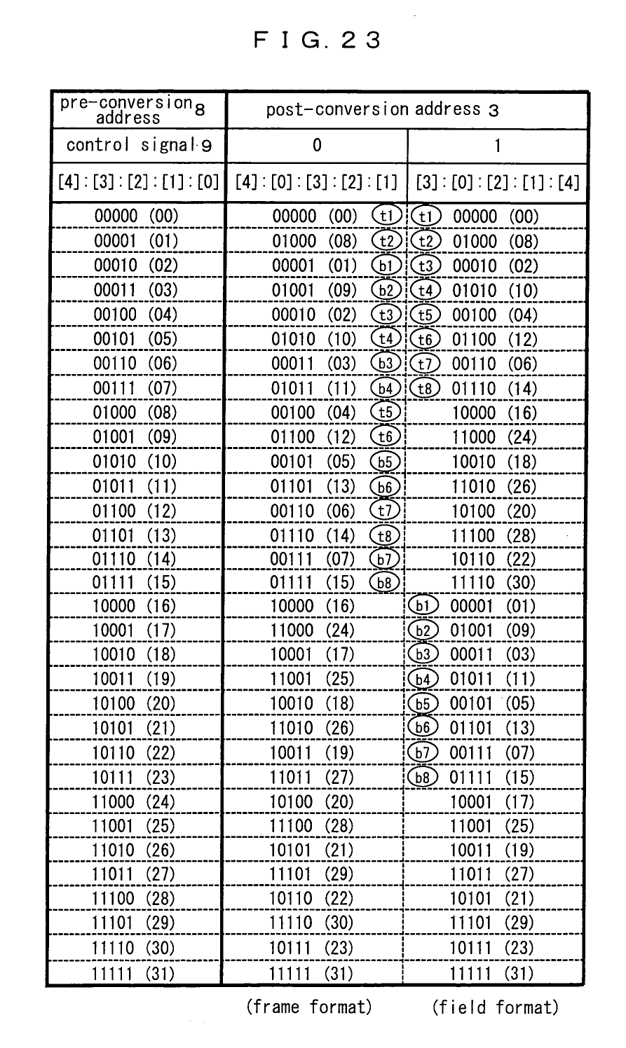

A configuration of a parallel operation apparatus of the SIMD type according to an embodiment 7 of the present invention is the same as the configuration shown in FIG. 1 according to the embodiment 1, except for the configuration of the address conversion unit 7. FIG. 22 illustrates a configuration of an address conversion unit 7 according to the embodiment 7. FIG. 23 shows an operation of the address conversion unit 7.

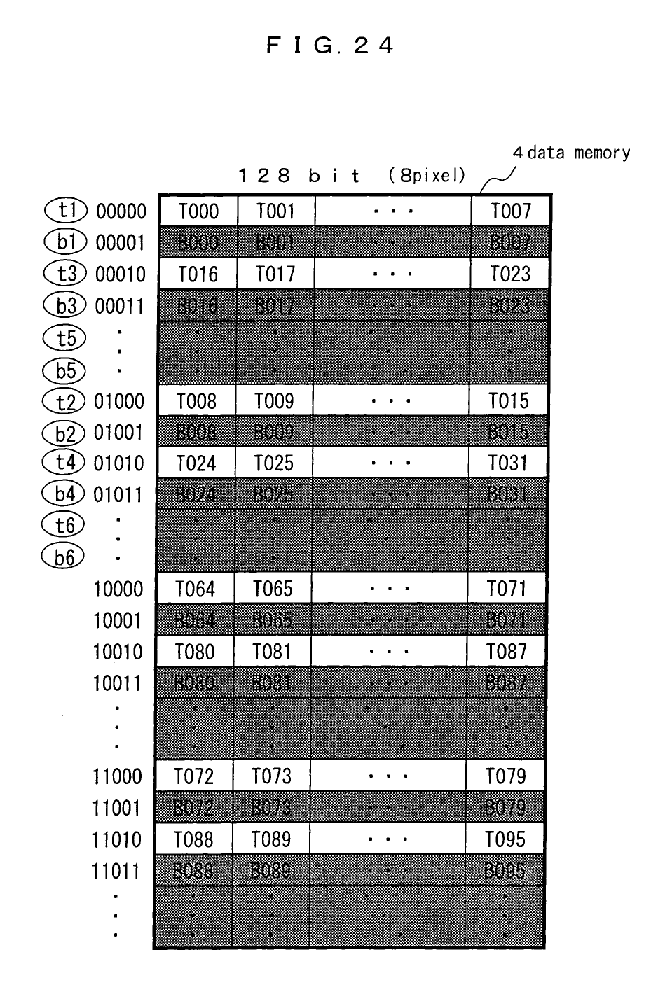

FIG. 24 shows the case where an image comprised of horizontal 16 pixels×vertical 16 pixels each having 16 bits is disposed in the data memory 4 in the frame format. A line of the image cannot be disposed in a line of the memory, therefore arranging a surplus part of the line in a position eight lines below.

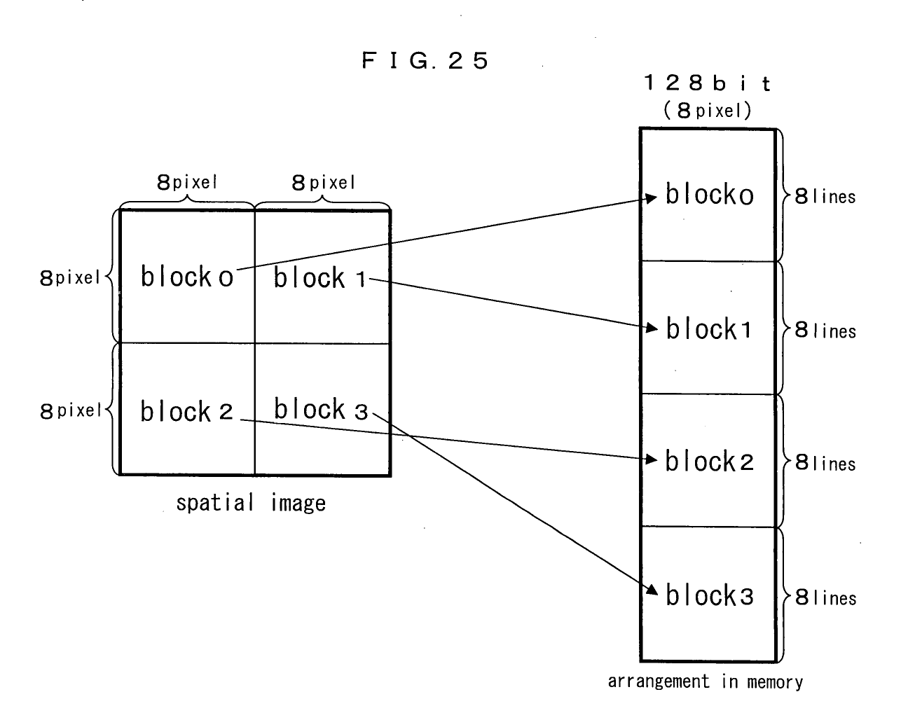

FIG. 25 shows a relationship between the image and image arrangement in the memory. The arrangement is often employed because the image comprised of horizontal eight pixels X vertical eight pixels, which is called a block used in MPEG, can be disposed in a lump, and image called a macro block comprised of four blocks is arranged in the order of encoding or decoding.

In the foregoing case, providing that the serial addresses are given to the address storage register 6 and the conversion operation shown in FIG. 23 is followed, the control signal 9 is set to “0”. By doing so, the serial addresses are converted into the effective address order, and the post-conversion addresses 3 are used to thereby execute the read. Thus, the image can be obtained in the frame format though it is necessary to execute the read twice with respect to a line of the image in such manner that left-side eight pixels of a line of the image are read in the first read, and right-side eight pixels of the line of the image are read in the second read.

Further, the image can be obtained in the field format by setting the control signal 9 to “1”.

Below is provided a description in more detail. In FIG. 23, address reference symbols t1, t2, b1, b2, t3, t4, b3, b4, t5, t6, b5, b6, t7, t8, b7, b8 . . . are shown in the method of changing the bit order when the control signal 9 is “0”. The address reference symbols are obtained by converting the frame format t1, b1, t3, b3, t5, b5 . . . t2, b2, t4, b4, t6, b6 . . . , which is shown in FIG. 24, again into the frame format. The address reference symbols are converted into the field format when the control signal 9 is “1”, as t1, t2, t3, t4, t5, t6, t7, t8 . . . b1, b2, b3, b4, b5, b6, b7, b8 . . . .

As described, according to the present embodiment, no program or data rearrangement responding to the respective frame and field formats is necessary. The image can be obtained in either frame format or field format by changing over the control signal 9.

### Embodiment 8

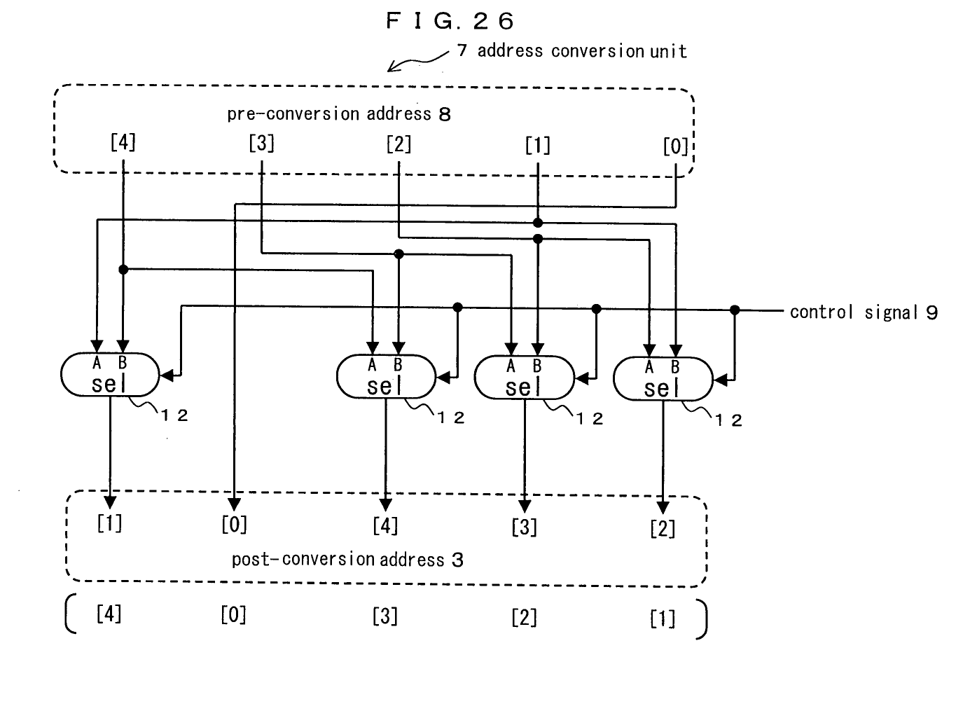

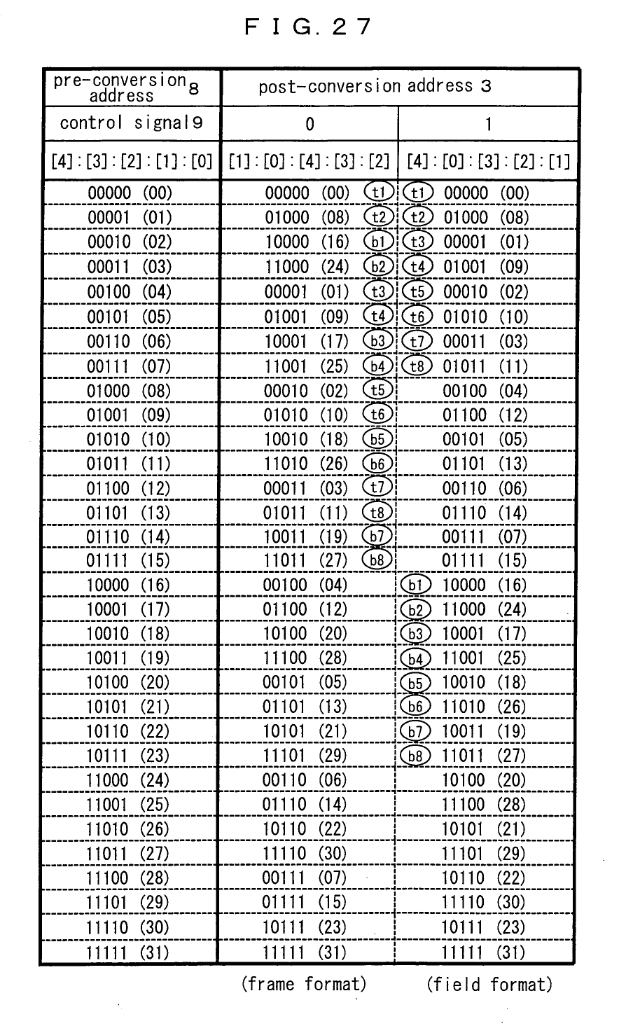

A configuration of a parallel operation apparatus of the SIMD type according to an embodiment 8 of the present invention is the same as the configuration shown in FIG. 1 according to the embodiment 1, except for the configuration of the address conversion unit 7. FIG. 26 illustrates a configuration of an address conversion unit 7 according to the embodiment 8. FIG. 27 shows an operation of the address conversion unit 7.

FIG. 28 shows the case where an image comprised of horizontal 16 pixels×vertical 16 pixels each having 16 bits is disposed in the data memory 4 in the field format. A line of the image cannot be disposed in a line of the memory, therefore arranging a surplus part of the line in a position eight lines below.

In the foregoing case, providing that the serial addresses are given to the address storage register 6 and the conversion operation shown in FIG. 27 is followed, the control signal 9 is set to “0”. By doing so, the serial addresses are converted into the effective address order, and the post-conversion addresses 3 are used to thereby execute the read. Thus, the image can be obtained in the frame format though it is necessary to execute the read twice with respect to a line of the image in such manner that left-side eight pixels of a line of the image are read in the first read, and right-side eight pixels of the line of the image are read in the next read.

Further, the image can be obtained in the field format by setting the control signal 9 to “1”.

Below is provided a description in more detail. In FIG. 27, address reference symbols t1, t2, b1, b2, t3, t4, b3, b4, t5, t6, b5, b6, t7, t8, b7, b8 . . . are shown in the method of changing the bit order when the control signal 9 is “0”. The address reference symbols are obtained by converting the field format t1, t3, t5, t7 . . . t2, t4, t6, t8 . . . b1, b3, b5, b7 . . . b2, b4, b6, b8 . . . , which is shown in FIG. 28, are converted into the frame format. The address reference symbols are converted into the field format when the control signal 9 is “1”, as t1, t2, t3, t4, t5, t6, t7, t8 . . . b1, b2, b3, b4, b5, b6, b7, b8 . . . .

As described, according to the present embodiment, no program or data rearrangement responding to the respective frame and field formats is necessary. The image can be obtained in either frame format or field format by changing over the control signal 9.

Further, the different configurations of the respective address conversion unit 7 shown in the embodiments 1 though 8 can be combined, in which case a plural kinds of conversion methods are changed over in response to the control signal 9. In such a manner, in the case where the image comprised of horizontal eight pixels×vertical eight pixels each having 16 bits is disposed in the memory in the frame format or field format in consequence of, for example, combining the embodiments 1 and 2, the image can be read in either of the formats.

Further, the embodiments 1 through 8 employ the image comprised of horizontal eight pixels×vertical eight pixels each having 16 bits and the image comprised of horizontal 16 pixels×vertical 16 pixels each having 16 bits in the respective descriptions, however, the configuration of the image is not limited thereto.

### Embodiment 9

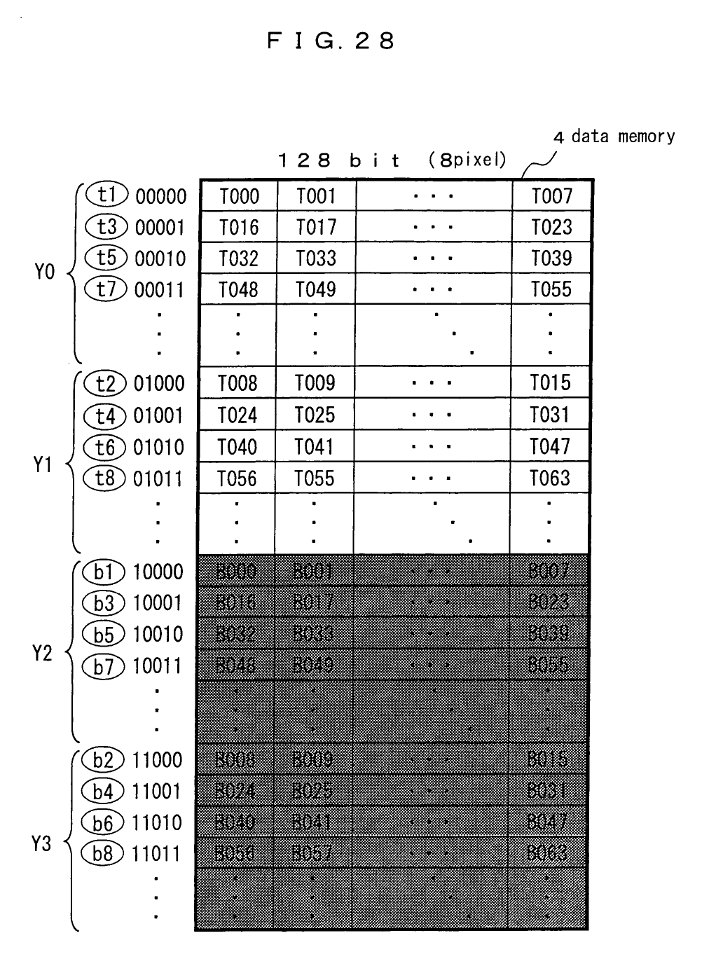

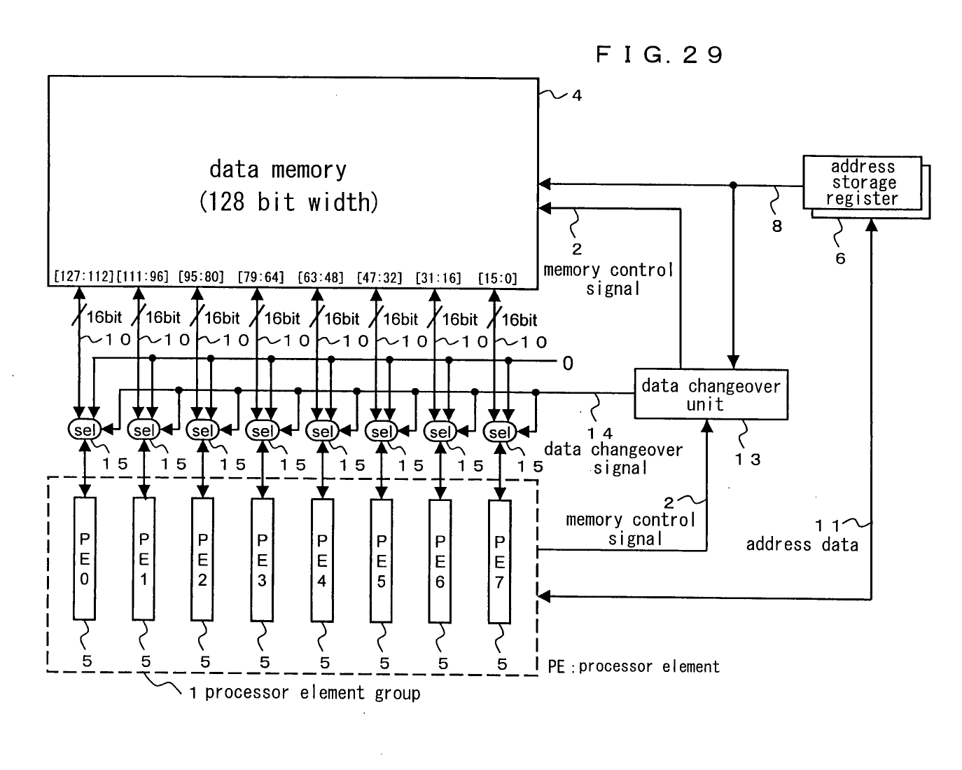

FIG. 29 illustrates a configuration of a parallel operation apparatus of the SIMD type according to an embodiment 9 of the present invention. Any component shown in FIG. 29, which is identical to the components of FIG. 1 is simply provided with the same reference symbol and not described in the present embodiment. In the embodiment 9, a data changeover unit 13 is provided in place of the address conversion unit 7.

In the data changeover unit 13, in the case where a read request is inputted to the memory control signal 2 from the processor element group 1, an address is inputted at the same time from the address storage register 6 to thereby judge whether or not the address satisfies conditions. When the address satisfies the conditions, the read request is outputted to the data memory 4, and data changeover selectors 15 are set by means of a data changeover signal 14 in such manner that memory input/output data 10 is inputted to the processor elements 5.

When the address does not satisfy the conditions, the read request is not outputted to the data memory 4, and the data changeover selectors 15 are set in such manner that “0” is inputted to the processor elements 5.

When a write request is outputted to the memory control signal 2, the data changeover unit 13 always outputs the write request to the data memory 4, and sets the data changeover selectors 15 in such manner that the output data of the processor elements 5 is outputted to the data memory 4.

A read control by means of CBP (encoding block pattern) of MPEG decoding is described.

It is assumed that the encoding data is disposed as shown in FIG. 28. Addresses 00000-00111 are referred to as YO block, 01000-01111 as Y1 block, 10000-10111 as Y2 block, and 11000-11111 as Y3 block. In the present example, Yn (n=0-3) block denotes a block comprised of horizontal eight pixels×vertical eight pixels with respect to a luminance element of a macro block. When a bit value of the CBP corresponding to a block is “0”, it is unnecessary to read data in the block.

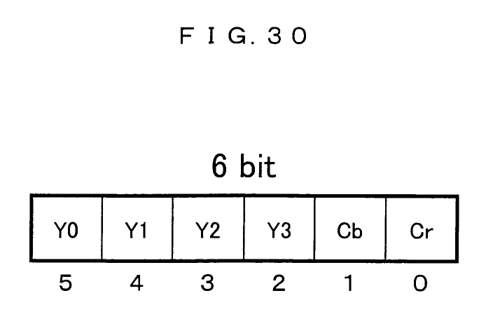

FIG. 30 illustrates a configuration of the bits in the CBP at the time of 4:2:0 format.

For example, when a highest-order bit of the CBP is “0”, it is unnecessary to read the encoding data in the Y0 block.

The data changeover unit 13 converts the inputted address by means of a conversion table, and negates the read request when the bit value of the CBP indicated by the converted value is “0” and sets the data changeover selectors 15 so that “0” is inputted to the respective processor elements 5 by means of the data changeover signal 14.

When the bit value of the CBP corresponding to the block is “1”, the read request is outputted to the data memory 4, the data changeover selectors 15 are set in such manner that the memory input/output data 10 is inputted to the processor elements 5.

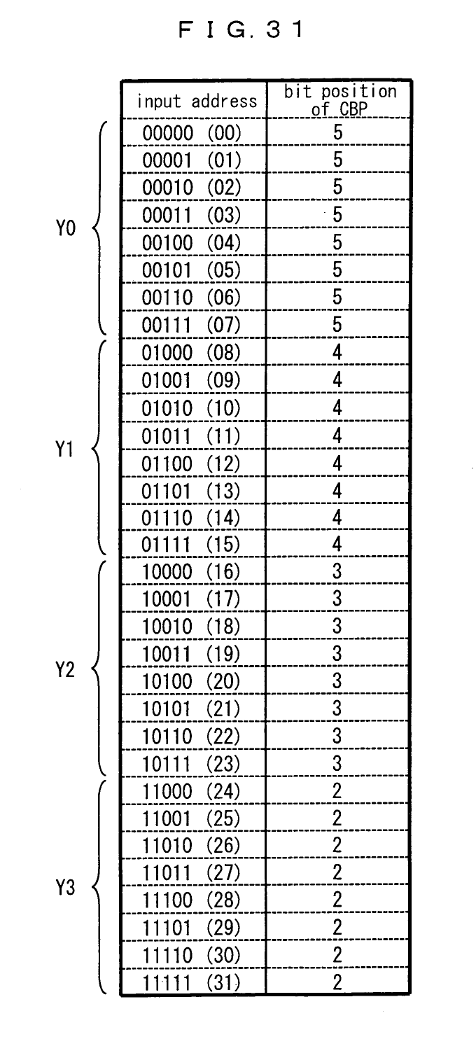

The conversion table for the inputted address is shown in FIG. 31.

According to the foregoing method, the read of any unnecessary data is halted in response to the address value, and power consumption can be thereby reduced eliminating any unnecessary access to the memory.

### Embodiment 10

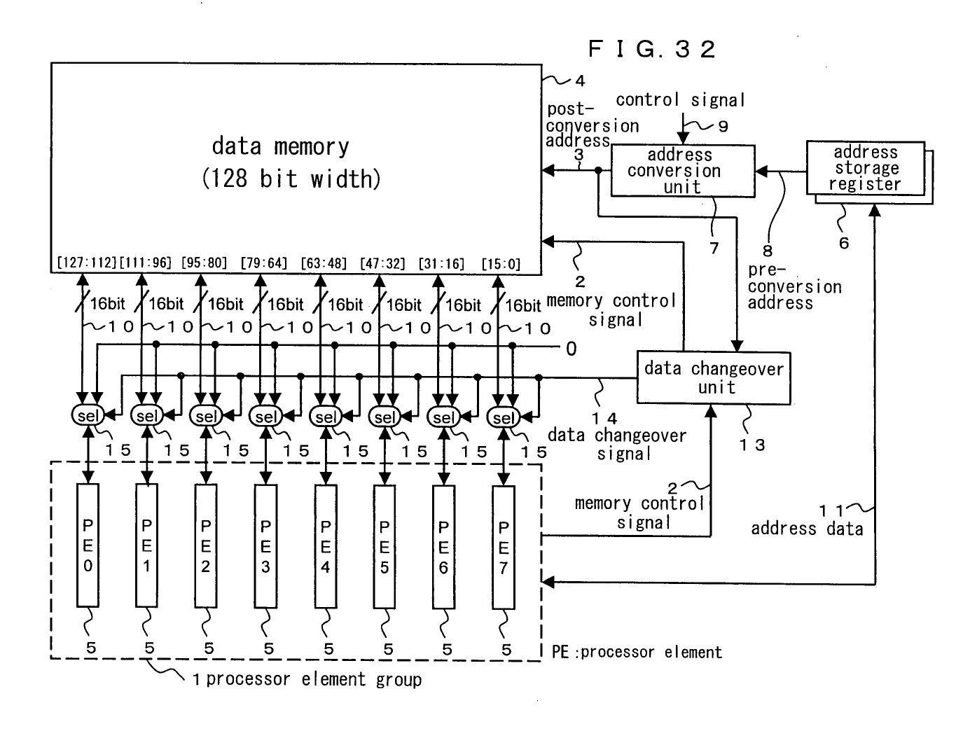

FIG. 32 illustrates a parallel operation apparatus of the SIMD type according to an embodiment 10 of the present invention. Any component shown in FIG. 32, which is identical to the components of FIG. 1, is provided with the same reference symbol, and not described in the present embodiment. In the present embodiment, the address conversion unit 7 and the data changeover unit 13 are both provided.

An operation of the SIMD-type parallel operation apparatus in writing with respect to the data memory 4 is described.

The processor element group 1 outputs the write request to the memory control signal 2. The data changeover unit 13, in response to the receipt of the write request signal, outputs the write request to the data memory 4 and sets the data changeover selectors 15 in such manner that the output data of the processor elements 5 is outputted to the data memory 4. The data memory 4 receives the write request, and correspondingly stores the data outputted from the processor elements 5 in a position indicated by the post-conversion address 3 in which the pre-conversion address 8 is converted by means of the address conversion unit 7.

An operation of the SIMD-type parallel operation apparatus in reading with respect to the data memory 4 is described.

The processor element group 1 outputs the read request to the memory control signal 2. The data conversion unit 13, in response to the receipt of the signal, judges whether or not the post-conversion address 3 from the address conversion unit 7 satisfies the conditions, and outputs the read request to the data memory 4 when the conditions are satisfied, and further sets the data changeover selectors 15 in such manner that the memory input/output data 10 is inputted to the processor elements 5. The data memory 4 receives the read request, and correspondingly outputs the data in the position indicated by the post-conversion address 3 from the address conversion unit 7 to the respective processor elements 5.

Further, when the post-conversion address 3 does not satisfy the conditions, the data changeover unit 13 does not output the read request to the data memory 4, and sets the data changeover selectors 15 in such manner that “0” is inputted to the processor elements 5. As a result, “0” is inputted to the respective processor elements 5.

According to the foregoing method, neither the program nor the rearrangement of the data corresponding to the frame format or field format is necessary, and the image can be obtained in either the frame format or field format by the changeover of the control signal 9. Further, the read of any unnecessary data can be halted by means of the address value, which eliminates any unnecessary access to the memory thereby reducing the power consumption.

While the invention has been described and illustrated in detail, it is to be clearly understood that this is intended by way of illustration and example only and is not to be taken by way of limitation, the spirit and scope of this invention being limited only be the terms of the following claims.

1. A parallel operation apparatus of a SIMD type comprising:
a processor element group of the SIMD type including a plurality of processor elements, wherein the respective processor elements simultaneously execute an identical operation;
a data memory accessible from the respective processor elements in the processor element group; and
an address conversion unit for converting an address with respect to the data memory accessed by the processor elements in accordance with a control signal by changing bit positions of the address.

2. A parallel operation apparatus of a SIMD type as claimed in claim 1, wherein
the address conversion unit rearranges a first bit, a second bit, and a third bit from a lower order of address data respectively to the second bit, the third bit, and the first bit from the lower order in the change of the bit positions.

3. A parallel operation apparatus of a SIMD type as claimed in claim 1, wherein
the address conversion unit rearranges a first bit, a second bit, and a third bit from a lower order of address data respectively to the third bit, the first bit, and the second bit from the lower order in the change of the bit positions.

4. A parallel operation apparatus of a SIMD type as claimed in claim 1, wherein
the address conversion unit rearranges a first bit, a second bit, a third bit, a fourth bit, and a fifth bit from a lower order of address data respectively to the first bit, the third bit, the fourth bit, the fifth bit, and the second bit from the lower order in the change of the bit positions.

5. A parallel operation apparatus of a SIMD type as claimed in claim 1, wherein
the address conversion unit rearranges a first bit, a second bit, a third bit, a fourth bit, and a fifth bit from a lower order of address data into the first bit, the fifth bit, the second bit, the third bit, and the fourth bit from the lower order in the change of the bit positions.

6. A parallel operation apparatus of a SIMD type as claimed in claim 1, wherein
the address conversion unit implements changeovers, with respect to a first bit, a second bit, a third bit, a fourth bit, and a fifth bit from a lower order of address data to an arrangement state of the fifth bit, the first bit, the second bit, the third bit, and the fourth bit from the lower order and to an arrangement state of the fifth bit, the second bit, the third bit, the fourth bit, and the first bit from the lower order in the change of the bit positions.

7. A parallel operation apparatus of a SIMD type as claimed in claim 1, wherein
the address conversion unit implements changeovers, with respect to a first bit, a second bit, a third bit, a fourth bit, and a fifth bit from a lower order of address data to an arrangement state of the fifth bit, the fourth bit, the first bit, the second bit, and the third bit from the lower order and to an arrangement state of the fifth bit, the first bit, the second bit, the third bit, and the fourth bit from the lower order in the change of the bit positions.

8. A parallel operation apparatus of a SIMD type as claimed in claim 1, wherein
the address conversion unit implements changeovers, with respect to a first bit, a second bit, a third bit, a fourth bit, and a fifth bit from a lower order of address data to an arrangement state of the fourth bit, the first bit, the second bit, the third bit, and the fifth bit from the lower order and to an arrangement state of the fourth bit, the second bit, the third bit, the fifth bit, and the first bit from the lower order in the change of the bit positions.

9. A parallel operation apparatus of a SIMD type as claimed in claim 1, wherein
the address conversion unit implements changeovers, with respect to a first bit, a second bit, a third bit, a fourth bit, and a fifth bit from a lower order of address data to an arrangement state of the fourth bit, the fifth bit, the first bit, the second bit, and the third bit from the lower order and to an arrangement state of the fourth bit, the first bit, the second bit, the third bit, and the fifth bit from the lower order in the change of the bit positions.

10. A parallel operation apparatus of a SIMD type comprising both of the address conversion units claimed in claims 2 and 3.

11. A parallel operation apparatus of a SIMD type comprising at least two or more from any of the address conversion units claimed in claims 4 through 9.

12. A parallel operation apparatus of a SIMD type comprising:
a SIMD-type processor element group including a plurality of processor elements, wherein the respective processor elements simultaneously execute an identical operation;
a data memory accessible from the respective processor elements; and
a data changeover unit for negating a read request for an address which does not fall under conditions and inputting fixed data to the processor elements.

13. A parallel operation apparatus of a SIMD type comprising:
a processor element group of the SIMD type including a plurality of processor elements, wherein the respective processor elements simultaneously execute an identical operation;
a data memory accessible from the respective processor elements in the processor element group;
an address conversion unit for converting an address with respect to the data memory accessed by the element operation processors in accordance with a control signal by changing bit positions of the address; and
a data changeover unit for negating a read request for an address which does not fall under conditions and inputting fixed data to the element operation processors.
